(19) United States
(12) Patent Application Publication
(10) Pub. No.: US 2020/0092284 A1
(43) Pub. Date: Mar. 19, 2020

(54) AUTHENTICATION METHOD AND SYSTEM

(71) Applicant: Alibaba Group Holding Limited, Georgetown (KY)

(72) Inventors: Hongru ZHU, Georgetown (KY); Kepeng LI, Georgetown (KY); Kang WANG, Georgetown (KY)

(21) Appl. No.: 16/571,790

(22) Filed: Sep. 16, 2019

(30) Foreign Application Priority Data
Sep. 19, 2018 (CN) 201811097496.3

(51) Int. Cl. H04L 29/06

(52) U.S. Cl. CPC H04L 63/0853; H04L 63/1416; H04L 2463/082; H04L 63/061; H04L 63/107

(57) ABSTRACT

Various embodiments of the present disclosure disclose an authentication method and system. A method comprises: acquiring, by a client terminal, signature information, a first value, and an authentication factor, wherein the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, wherein the server verifies the authentication information. The present disclosure solves the technical problem of low authentication accuracy caused by failure to effectively detect the occurrence of a cloning operation in authentication methods in the prior art.

### CROSS-REFERENCE TO RELATED APPLICATION

This application claims priority to China Patent Application No. 201811097496.3 filed Sep. 19, 2018, by Hongru Zhu et al., which is hereby incorporated by reference.

### TECHNICAL FIELD

The present disclosure relates to the field of two-factor authentication, and in particular, to an authentication method and system.

### BACKGROUND

Two-factor authentication (2FA) has been an internationally recognized enhanced safeguard that is most effective for user account security. Common two-factor authentication schemes, such as a short message service authentication code, an RSA token (TOTP), and biological information have problems such as inconvenient operation, possible halfway data hijacking, and leakage of user privacy.

Universal 2nd Factor (U2F), like a domestic protection mechanism for 2nd-generation USB keys, uses two factors (a password and a device capable of interacting with a user) to protect user account and privacy. During registration, the user uses a U2F device supported by a server to bind the account to the device. When performing a login verification operation, the server, when appropriate, prompts the user to plug in the device and perform a key-pressing operation; an encryption device signs data and sends the data to the server; the server performs verification; and if the verification succeeds, then the user can successfully log in. With the protection of the 2nd factor (the encryption device), the user may select to not set a password or to use a simpler password.

The working principle is as follows: when the user logs in to the server to register information, the U2F device of the user generates an asymmetric key pair, where a private key is reserved in the encryption device and cannot be read by a hacker, while a public key is transmitted to the server and is associated with the account corresponding to the user by the server; when the user logs in to the server to verify information, the user uses the private key in the U2F device to sign a challenge value of the server, and the server uses the corresponding public key to perform verification, where the private key in the device of the user can be used for the signing operation only after the private key is unlocked (for example, by key-pressing) by the user.

Specifically, the process of user registration is as follows: a terminal device of the user prompts the user to select a FIDO (Fast IDentity Online) authentication factor; the user uses the U2F device to unlock the FIDO authentication factor; the terminal device of the user generates a new public key/private key pair unique to a local device, an online service, and the user account; and the terminal device of the user sends the public key to the online service, while the private key and the local authentication means (for example, the U2F device) cannot leave the local device.

The process of user login is as follows: the server of the online service issues a challenge to the user to request the user to log in; the user uses the method in registration to unlock the FIDO authentication factor; the terminal device uses the account ID of the user provided by the online service server to select a correct private key and sign a challenge value of the online service; the terminal device sends the signed challenge value to the online service server; and the online service server uses a public key to verify the signature and returns a login response to the user.

FIDO U2F has become a new-generation, the most popular, and the most promising two-factor authentication means in recent years, and has advantages such as drive-free, native support for browsers (Chrome), convenient operation, high security (with the introduction of a cryptography chip), and simple design. Though the FIDO U2F standard is secure, the key derivation mechanism introduced in U2F is prone to exposing the FIDO U2F standard to security risks introduced by manufacturers in the following two points during implementation:

Security model risk: a U2F security model should be degraded in the degree of trust from chip-level security to a supplier level; namely, the chip-level security is untrusted because a master key (namely, a private key) in a chip of a U2F device can be easily cloned during delivery, sales, transportation, and other processes, and the U2F device is trusted only at delivery by the supplier. After the user is granted a U2F device, the user needs to be able to reset a master key of the U2F device to avoid the risk of leaking the master key (namely, the private key) introduced in the supply chain.

Clone detection risk: some service providers using the U2F mechanism do not perform corresponding risk control operations such as prompt and logout after a master key of a U2F device is cloned. Some manufacturers even do not implement anti-clone detection according to a standard protocol; as a result, an attacker can achieve login authentication according to a cloned master key.

In order to avoid the aforementioned two kinds of security risks, a counter may be used as a signal for detecting a cloned U2F device. The U2F device protocol includes using a counter to allow a session initiator to detect a problem in some cases. Each time the U2F device performs the verification operation, the value of the counter must be added by 1. The counter may be “global” (namely, a counter of a U2F token device is used for a plurality of application servers), or may be for a single application. The counter of the U2F device should start from 0. No matter if the counter is for each pair of keys (if there is enough memory), global (if there is memory restriction, then some privacy of the keys may be lost), or even between the two (for example, a key bucket sharing a counter, with a little privacy leakage), the U2F device remembers the count of the number of signing operations performed by the U2F device.

The U2F device sends an actual counter value back to the browser so as to relay the actual counter value to the session initiator after each signing operation. The U2F device further connects the counter value to a hash value of client data before signing, so that the session initiator can forcefully verify whether the counter value is tampered with by the browser. The server may compare a counter value currently sent by the U2F device with a counter value previously received during interaction with the same U2F device. If the current counter value is less than the previously received counter value, then it indicates that a plurality of U2F devices having the same key pair exist to interact with the session initiator (namely, the U2F device has been cloned).

As shown in FIG. 1, a normal U2F authentication process is as follows: step S11: a user logs in to a Web application on a browser side, enters a user name and a password, and the browser 102 sends the user name and the password processed by an algorithm such as a digest algorithm to an application server 104; step S12: the application server 104 verifies the password of the user; step S13: the application server 104 generates a challenge value after the application server 104 successfully verifies the user name and the password of the user; step S14: the application server 104 sends the generated challenge value to the browser 102 of the user; step S15: the browser 102 of the user sends the challenge value to the U2F device 106 of the user; step S16: the U2F device 106 of the user prompts the user whether to confirm this operation, and the user presses a button to confirm this login operation; step S17: the U2F device 106 of the user signs the challenge value according to its own master key (namely, a private key) and meanwhile generates the value of a counter, generates a response message including the counter value and the signature, and sends the response message to the browser 102; step S18: the browser 102 sends the response message including the counter value and the signature to the application server 104; step S19: the application server 104 verifies the signature in the response message according to a public key previously registered by the user; and step S110: if the verification succeeds, and if the counter received this time is incremented relative to the previously recorded counter_old, then the user login is allowed; otherwise, the user login is rejected.

Although the counter is a forceful clone signal, it is impossible to detect the occurrence of cloning in all cases. For example, if the original device has never been used since a cloning operation occurs, then in this case detection fails. Or, after cloning the master key (private key) of the U2F device, an attacker can perform signature verification on a challenge value sent by the application server so as to generate a large counter value Counter by himself.

At present, no effective solution has been proposed to address the problem of low authentication accuracy caused by failure to effectively detect the occurrence of a cloning operation in authentication methods in the prior art.

### SUMMARY

Embodiments of the present disclosure provide an authentication method and system, so as to solve at least the technical problem of low authentication accuracy caused by failure to effectively detect the occurrence of a cloning operation in authentication methods in the prior art.

According to one aspect of the embodiments of the present disclosure, an authentication method is provided, comprising: acquiring, by a client terminal, signature information, a first value, and an authentication factor, wherein the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, wherein the server verifies the authentication information.

According to another aspect of the embodiments of the present disclosure, an authentication method is further provided, comprising: sending, by a server, a challenge value to a client terminal; acquiring, by the server, authentication information returned by the client terminal, wherein the authentication information is generated based on signature information, a first value, and an authentication factor; the signature information is obtained by signing the challenge value, the first value is used for representing the number of operations of signing the challenge value, and the authentication factor is used for representing login information of the client terminal logging in to the server; and verifying, by the server, the authentication information.

According to another aspect of the embodiments of the present disclosure, an authentication system is further provided, comprising: a server, configured to send a challenge value; and a client terminal, having a communication relationship with the server, and configured to generate authentication information based on signature information, a first value, and an authentication factor, wherein the signature information is obtained by signing the challenge value, the first value is used for representing the number of operations of signing the challenge value, and the authentication factor comprises one of the following: a login time and a second value corresponding to a target application; and the server is further configured to verify the authentication information to obtain an authentication result.

According to another aspect of the embodiments of the present disclosure, an authentication method is further provided, comprising: acquiring, by a client terminal, signature information and authentication parameters, wherein the authentication parameters are used for representing login information and operation information of the client terminal logging in to a server; and generating, by the client terminal, authentication information based on the signature information and the authentication parameters.

According to another aspect of the embodiments of the present disclosure, an authentication method is further provided, comprising: acquiring, by a server, authentication information returned by a client terminal, wherein the authentication information is generated based on signature information and authentication parameters, and the authentication parameters are used for representing login information and operation information of the client terminal logging in to the server; and verifying, by the server, the authentication information.

According to another aspect of the embodiments of the present disclosure, a storage medium is further provided, comprising a stored program, wherein when the program is running, a device where the storage medium resides is controlled to perform the following steps: acquiring, by a client terminal, signature information, a first value, and an authentication factor, wherein the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, wherein the authentication information is authenticated by the server to obtain an authentication result.

According to another aspect of the embodiments of the present disclosure, a mobile device is further provided, comprising: a processor configured to run a program, wherein when the program is running, the following steps are performed: acquiring, by a client terminal, signature information, a first value, and an authentication factor, wherein the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, wherein the authentication information is authenticated by the server to obtain an authentication result.

According to another aspect of the embodiments of the present disclosure, an authentication system is further provided, comprising: a processor; and a memory, connected to the processor and configured to provide to the processor instructions for processing the following processing steps: acquiring, by a client terminal, signature information, a first value, and an authentication factor, wherein the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, wherein the authentication information is authenticated by the server to obtain an authentication result.

In the embodiments of the present disclosure, a client terminal acquires signature information, a first value, and an authentication factor, further generates authentication information according to the acquired information, and sends the authentication information to a server for verification, so as to achieve the purpose of Universal 2nd Factor authentication.

It is noted that the authentication information not only includes the signature information and the first value, but also includes the authentication factor, and the authentication factor is login information of the client terminal logging in to the server. As compared with the prior art, since an attacker cannot learn the authentication factor, the attacker cannot pass the two-factor authentication even if the attacker generates a large value; thus, the occurrence of a cloning operation can be effectively detected, and the technical effect of enhancing authentication accuracy and improving user experience can be achieved.

Accordingly, the solutions in the embodiments of the present disclosure solve the technical problem of low authentication accuracy caused by failure to effectively detect the occurrence of a cloning operation in authentication methods in the prior art.

While various embodiments in accordance with the present disclosure have been specifically described within this Summary, it is noted that the claimed subject matter are not limited in any way by these various embodiments.

### BRIEF DESCRIPTION OF THE DRAWINGS

The drawings described herein are intended to provide a better understanding of the present disclosure, and constitute a part of the present disclosure. The illustrative embodiments of the present disclosure and descriptions thereof are used to explain the present disclosure and not to limit the present disclosure in any negative way. In the accompany drawings:

FIG. 1 is an interaction diagram of two-factor authentication according to the prior art;

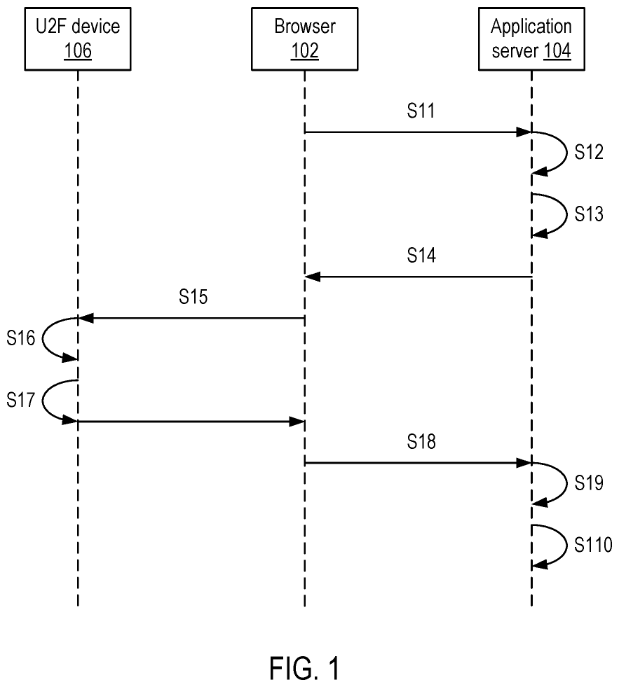

FIG. 2 is a hardware structural block diagram of a computer terminal (or mobile device) for implementing an authentication method according to an embodiment of the present disclosure;

FIG. 3 is a schematic diagram of a computer terminal as a sending end according to an embodiment of the present disclosure;

FIG. 4 is a flowchart of an authentication method according to Embodiment 1 of the present disclosure;

FIG. 5 is a flowchart of an alternative authentication method based on a login time according to an embodiment of the present disclosure;

FIG. 6 is a schematic diagram of an alternative login scheme based on a mask according to an embodiment of the present disclosure;

FIG. 7 is a flowchart of an alternative authentication method based on a mask according to an embodiment of the present disclosure;

FIG. 8 is a flowchart of an authentication method according to Embodiment 2 of the present disclosure;

FIG. 9 is a schematic diagram of an authentication apparatus according to Embodiment 3 of the present disclosure;

FIG. 10 is a schematic diagram of an authentication apparatus according to Embodiment 4 of the present disclosure;

FIG. 11 is a schematic diagram of an authentication system according to Embodiment 5 of the present disclosure;

FIG. 12 is a flowchart of an authentication method according to Embodiment 6 of the present disclosure;

FIG. 13 is a flowchart of an authentication method according to Embodiment 7 of the present disclosure; and

FIG. 14 is a structural block diagram of a computer terminal according to an embodiment of the present disclosure.

### DETAILED DESCRIPTION

In order to enable those skilled in the art to better understand the solutions of the present disclosure, the technical solutions in the embodiments of the present disclosure will be described clearly and completely below with reference to the drawings in the embodiments of the present disclosure. It is apparent that the described embodiments are merely some, rather than all of the embodiments of the present disclosure. Based on the embodiments of the present disclosure, all other embodiments obtained by those of ordinary skill in the art without making creative efforts shall fall within the protection scope of the present disclosure.

It should be noted that the terms “first,” “second,” and the like in the description and claims of the present disclosure and in the above drawings are used to distinguish similar objects and are not necessarily used to describe a specific sequence or order. It should be understood that these numbers may be interchanged where appropriate so that the embodiments of the present disclosure described herein can be implemented in orders other than those illustrated or described herein. In addition, the terms “include” and “have” and any variations thereof are intended to cover non-exclusive inclusions. For example, processes, methods, systems, products, or devices that include a series of steps or units are not limited to steps or units that are clearly listed, but may include other steps or units not clearly listed or inherent to these processes, methods, products, or devices.

First, explanations of some nouns or terms used in the description of the embodiments of the present disclosure are provided as follows:

U2F: an open authentication standard that strengthens and simplifies two-factor authentication using specialized USB, NFC (Near Field Communication) or BTLE (Bluetooth Low Energy) devices.

FIDO: the FIDO Alliance is an industry association founded in July 2012. The goal of FIDO is to create a set of open standard protocols, guarantee the interoperability between strong authentication technologies developed by various manufacturers, change the current mainstream way of online verification (namely, using passwords as the main verification means), and eliminate or weaken user dependence on passwords. The FIDO Alliance is exactly an organization which promotes strong authentication protocol standards to reduce reliance on passwords.

### Embodiment 1

According to this embodiment of the present disclosure, an embodiment of an authentication method is provided. It should be noted that the steps shown in the flowchart of the drawings may be performed in a computer system such as a set of computer-executable instructions. Although a logical order is shown in the flowchart, in some cases, the illustrated or described steps may be performed in a different order other than the one shown here.

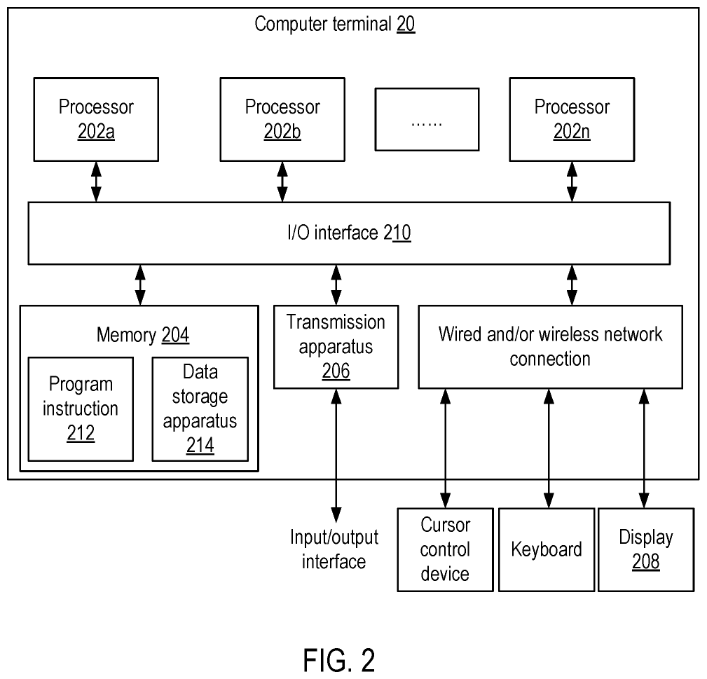

The method embodiment provided in Embodiment 1 of the present disclosure may be executed in a mobile terminal, a computer terminal, or a similar computing apparatus. FIG. 2 is a hardware structural block diagram of a computer terminal (or mobile device) for implementing an authentication method. As shown in FIG. 2, the computer terminal 20 (or mobile device 20) may include one or a plurality of (shown as 202a, 202b, . . . , 202n in the figure) processors 202 (the processor 202 may include, but is not limited to, a processing apparatus such as a microprocessor (MCU) or a programmable logic device (FPGA)), a memory 204 configured to store data, and a transmission apparatus 206 configured to implement a communication function. In addition, the computer terminal 20 may include a display 208, an input/output interface (I/O interface) 210, a universal serial bus (USB) port (which may be included as one of the ports for the I/O interface 210), a network interface, a power supply, and/or a camera. Those of ordinary skill in the art can understand that the structure shown in FIG. 2 is merely exemplary and does not limit the structure of the aforementioned electronic apparatus. For example, the computer terminal 20 may also include more or fewer components than those shown in FIG. 2, or have a different configuration from that shown in FIG. 2.

It should be noted that the one or plurality of processors 202 described above and/or other data processing circuits may generally be referred to herein as “data processing circuits.” The data processing circuit may be embodied in whole or in part as software, hardware, firmware, or any other combination. In addition, the data processing circuit may be a single, independent processing module, or may be combined in whole or in part into any of the other components in the computer terminal 20 (or mobile device). As involved in this embodiment of the present disclosure, the data processing circuit is used as a processor for controlling (for example, controlling a selection of a variable resistance terminal path connected to an interface).

The memory 204 may be configured to store software programs and modules of application software, such as program instructions 212/data storage apparatuses 214 corresponding to the authentication method in this embodiment of the present disclosure. The processor 202 executes the software programs and modules stored in the memory 204 so as to execute various functional applications and data processing, namely, implementing the authentication method described above. The memory 204 may include a high-speed random access memory and may also include a non-volatile memory such as one or a plurality of magnetic storage apparatuses, a flash memory, or other non-volatile solid-state memories. In some examples, the memory 204 may further include memories arranged remotely with respect to the processor 202. The remote memories may be connected to the computer terminal 20 via a network. Examples of the aforementioned network include, but are not limited to, the Internet, intranets, local area networks, mobile communication networks, and the combinations thereof.

The transmission apparatus 206 is configured to receive or send data via a network. Specific examples of the aforementioned network may include a wireless network provided by a communication provider of the computer terminal 20. In one example, the transmission apparatus 206 includes a network interface controller (NIC) that can be connected to other network devices through a base station so that it can communicate with the Internet. In one example, the transmission apparatus 206 may be a radio frequency (RF) module for wirelessly communicating with the Internet.

The display 208 may be, for example, a touch-screen liquid crystal display (LCD) that can enable a user to interact with a user interface of the computer terminal 20 (or mobile device).

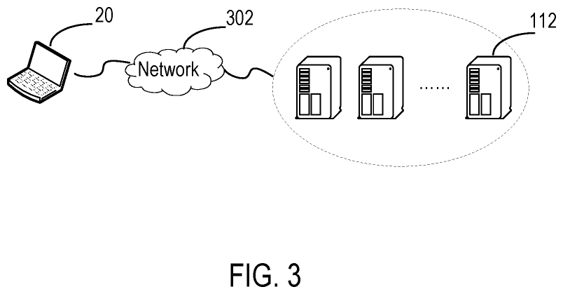

The hardware structural block diagram shown in FIG. 2 can be used not only as an exemplary block diagram of the aforementioned computer terminal 20 (or mobile device) but can also be used as an exemplary block diagram of the aforementioned server. In an alternative embodiment, FIG. 3 illustrates, in a block diagram, an embodiment of using the aforementioned computer terminal 20 (or mobile device) shown in FIG. 2 as a sending end. As shown in FIG. 3, the computer terminal 20 (or mobile device) may be connected, via a data network 302 or electronically, to one or a plurality of servers 112, for example, security servers, resource servers, or game servers. In an alternative embodiment, the aforementioned computer terminal 20 (or mobile device) may be any mobile computing device or the like. The data network 302 connection may be a local area network connection, a wide area network connection, an Internet connection, or other types of data network connections. The computer terminal 20 (or mobile device) may perform to access a network service that is performed by a server 112 (for example, a security server) or a group of servers. A network server is a network-based user service such as a social networking service, a cloud resource, email, online payment, or other online applications.

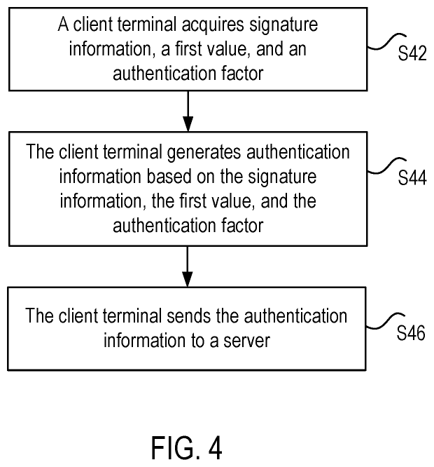

In the aforementioned operating environment, the present disclosure provides an authentication method shown in FIG. 4. FIG. 4 is a flowchart of an authentication method according to Embodiment 1 of the present disclosure. As shown in FIG. 4, the method includes the following steps:

Step S42: a client terminal acquires signature information, a first value, and an authentication factor, where the signature information is obtained by signing a challenge value sent by a server, the first value is used for representing the number of operations of signing the challenge value, and the authentication factor is used for representing login information of the client terminal logging in to the server.

Optionally, the client terminal may be connected to an authentication device, and the authentication factor may be stored in a single-chip microcomputer or a secure element of the authentication device.

Optionally, the authentication factor may include at least one of the following: a login time and the number of logins.

Specifically, the aforementioned client terminal may be a computer terminal, the aforementioned server may be an application server, and the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value).

Since it is impossible to detect the occurrence of cloning in all cases, in order to avoid the occurrence of cloning, an authentication factor that cannot be learned by an attacker may be added which may be, for example, login information of the client terminal logging in to the application server last time; the authentication factor may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed, except that a new authentication factor is added in the single-chip microcomputer so that no new security risks are introduced. When the SE has a large storage capacity, the authentication factor may be stored in the SE in order to increase security.

Step S44: the client terminal generates authentication information based on the signature information, the first value, and the authentication factor.

Step S46: the client terminal sends the authentication information to the server, where the server verifies the authentication information.

In an alternative solution, in the two-factor authentication process, the application server may send a challenge value to the client terminal; the client terminal uses the U2F device to sign the challenge value according to its own master key (namely, a private key) to obtain signature information and meanwhile generate the value of a counter, read a newly added authentication factor, further generate authentication information according to the aforementioned information, and forward the authentication information to the application server through the browser for two-factor authentication. After receiving the authentication information, the application server needs to separately verify the signature information, the value of the counter, and the authentication factor, and can determine that the two-factor authentication succeeds only when all the information passes the verification.

In the solution provided in Embodiment 1 of the present disclosure, the client terminal acquires signature information, a first value, and an authentication factor; further generates authentication information according to the acquired information; and sends the authentication information to the server for verification, so as to achieve the purpose of Universal 2nd Factor authentication.

It is noted that the authentication information not only includes the signature information and the first value, but also includes the authentication factor, and the authentication factor is login information of the client terminal logging in to the server. As compared with the prior art, since an attacker cannot learn the authentication factor, the attacker cannot pass the two-factor authentication even if the attacker generates a large value; thus, the occurrence of a cloning operation can be effectively detected, and the technical effect of enhancing authentication accuracy and improving user experience can be achieved.

Accordingly, the solution of Embodiment 1 provided in the present disclosure solves the technical problem of low authentication accuracy caused by failure to effectively detect the occurrence of a cloning operation in authentication methods in the prior art.

In the aforementioned embodiment of the present disclosure, step S42 in which the client terminal acquires the login time includes:

Step S4202: the client terminal reads a historical login time from the authentication device, where the historical login time is used for representing a login time of the client terminal successfully logging in to the server last time.

Specifically, each time the client terminal successfully logs in to the server, a login time of the client terminal successfully logging in to the server may be recorded in the single-chip microcomputer of the U2F device, so that each time two-factor authentication is performed, a login time of the client terminal successfully logging in to the application server last time can be directly read from the single-chip microcomputer of the U2F device.

Step S4202: the client terminal reads a current login time, where the current login time is used for representing a login time of the client terminal currently logging in to the server.

Specifically, the client terminal may read a current login time from the U2F device itself or the client terminal. After the client terminal successfully logs in to the application server this time, the time will be used as a “historical login time” in the next two-factor authentication.

It should be noted that the aforementioned login time may depend on the time of the U2F device or the client terminal and does not need to be synchronized with the local time of the application server. The application server only needs to store the login time sent by the client terminal without comparing the login time with the local time.

Optionally, in the case that the client terminal logs in to the server for the first time, the historical login time is used for representing a time of performing a registration operation on the server by the client terminal, where in the case that the client terminal performs the registration operation on the server, the client terminal generates the login time according to the current login time.

Specifically, if the client terminal logs in to the application server for the first time, then a time of performing a registration operation on the application server by the client terminal may be used as the historical login time. For the registration operation, only the current time may be acquired due to the absence of the historical login time.

In an alternative solution, the client terminal may read a current login time (timestamp_current) and a last successful login time (timestamp_old) through the U2F device, and send them in authentication information to the application server so that the application server performs two-factor authentication.

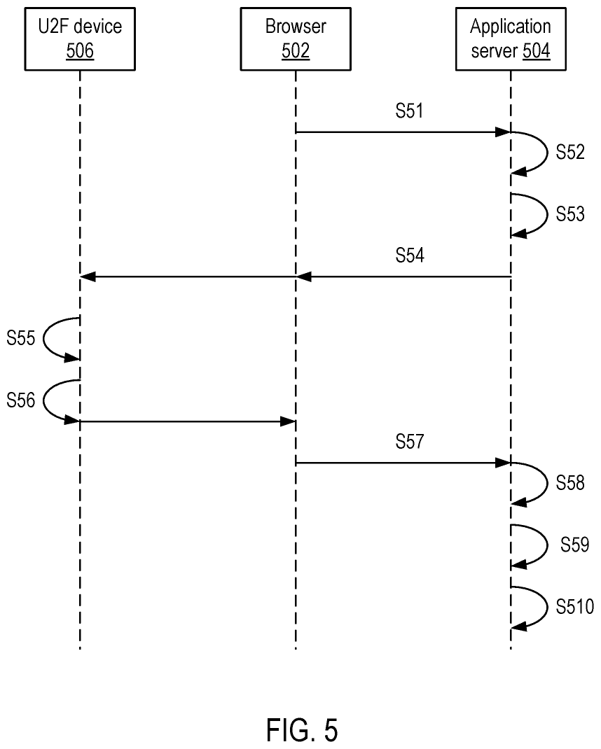

For example, an authentication method based on a login time is shown in FIG. 5. A browser 502 is installed on a client terminal, and the client terminal is connected to a U2F device. The method may include the following steps:

Step S51: a user logs in to a Web application (namely, the aforementioned target application) on the browser side, enters a user name and a password, and the browser 502 sends the user name and the password processed by a digest algorithm to the application server 504.

Step S52: the application server 504 verifies the user name and the password of the user.

Step S53: the application server 504 generates a challenge value after the application server 504 successfully verifies the user name and the password of the user.

Step S54: the application server 504 sends the challenge value to the browser 502 of the user, and the browser 502 of the user sends the challenge value to the U2F device 506 of the user.

Step S55: the U2F device 506 of the user prompts the user whether to confirm this operation, and the user presses a key to confirm this login operation.

Step S56: the U2F device 506 of the user signs the challenge value according to its own master key (namely, a private key) and meanwhile generates the value of a counter, generates a response message (namely, the aforementioned authentication information) including the counter value and the signature, and sends the response message to the browser 502.

Each time the user performs a key-pressing operation, the U2F device 506 needs to read, from the device itself or a computer to which the U2F device 506 is connected, a current login time (timestamp_current) and a last successful login time (timestamp_old), and send them in a response message to the browser 502. Upon each successful login, the U2F device 506 needs to record the current time (timestamp_current) that will be used as a “last login time” (timestamp_old) for a next login response, and meanwhile send the time in a response message to the browser 502, and the time is finally sent to the application server 504.

If it is the first login operation, then timestamp_old is the time of a registration operation. For the registration operation, only the current time needs to be sent. The current time and the last login time may be stored in the single-chip microcomputer of the U2F device 506 instead of being stored in the SE (Secure Element) because the SE generally has a limited storage space.

Step S57: the browser 502 sends the corresponding information received from the U2F device 506, including the signature, the counter value (Counter), the last login time (timestamp_old), and the current login time (timestamp_current) to the application server 504.

Step S58: the application server 504 verifies the signature in the authentication information according to a public key previously registered by the user.

Step S59: after receiving the counter value sent from the browser 502 this time, the application server 504 reads an old value of the counter (counter_old) and a last login time (timestamp_last) that are previously recorded.

Step S510: the application server 504 compares the counter value sent from the browser 502 that is received this time with the old counter value (counter_old) that is read, compares the last successful login time (timestamp_old) sent from the browser 502 with the recorded last successful login time (timestamp_last), and executes a risk control policy. With respect to the counter value Counter, the specific risk control policy is described in the subsequent content of this embodiment. With respect to a timestamp, if the application server 504 finds that the (timestamp_old) sent from the browser 502 is inconsistent with the recorded last successful login time (timestamp_last), then the application server 504 may warn the user of risks so that the user performs secondary confirmation, or the application server 504 may revoke the U2F authentication factor.

Upon each successful login, the application server 504 stores a previous value of the counter (Counter) sent from the browser 502 of the user that passes the verification each time and records a current login time (timestamp_current) sent from the browser 502, where the time will be used as a last login time (timestamp_last) for a next login operation.

The current login time and last login time sent by the U2F device 506 may depend on the time of the U2F device 506 or the computer to which the U2F device 506 is connected and do not need to be synchronized with the local time of the application server 504, because after receiving the two times, the application server 504 only needs to compare them with the login time received and recorded last time without comparing them with the local time.

Through the aforementioned solution, a timestamp is added in a response message, so that after cloning the master key (private key) of the U2F device 506, even if an attacker performs signature verification on a challenge value sent by the application server 504 to generate by himself a large counter value Counter which is larger than a previous one, the attacker cannot learn the last login time of the user and also cannot pass the verification, meaning that an authentication factor is added.

In the aforementioned embodiment of the present disclosure, step S42 in which the client terminal acquires the number of logins includes:

Step S4222: the client terminal reads a historical value corresponding to a target application from the authentication device where the target application corresponds to the server, and the historical value is used for representing the number of historical logins of the client terminal logging in to the server.

Specifically, since a user may log in to different applications through the browser, different sub-counters (sub_counter) may be set for different applications in order to determine the number of logins to different applications, and the number of logins of the user logging to the application is represented by a sub-counter value. The U2F device may store a mapping table to record a counter value (sub_counter) corresponding to each application (AppID). If the SE (Secure Element) of the U2F device has a limited storage space, then this mapping table may be stored in the single-chip microcomputer of the U2F device. Each time the user successfully logs in to an application, the value of the sub-counter corresponding to the application is incremented by 1.

For example, for the Atmel ATECC508A chip, a total of two counter values Counter exist, each having an upper limit of 2097151. Assuming one U2F device can serve 20 applications, and a counting range of 100,000 may be allocated to each application. If a user logs in to the application 10 times a day, namely 3,650 times a year, then the U2F device can be used for about 27 years before an overflow occurs. In most application scenarios, this counting range is sufficient. The mapping table stored in the U2F is shown in the following Table 1:

TABLE 1

| | | | | next_sub_counter |
|---|---|---|---|---|
| | | | | value to be |
| | | | | uploaded to the |
| Serial | Application | Counter | Stored | application |
| number | ID | range | stored_sub_counter | server next time |
| 1 | Facebook | 1-100000 | For example, 5 | 6 |
| 2 | Gmail | 1-100000 | For example, 16 | 17 |
| 3 | Dropbox | 1-100000 | For example, 7 | 8 |
| 4 | Github | 1-100000 | For example, 9 | 10 |
| . . . | . . . | . . . | . . . | . . . |
| 20 | AppID_20 | 1-100000 | For example, 19 | 20 |

Corresponding to each application ID (AppID), the value of the sub-counter stored (stored_sub_counter) needs to fall within a pre-allocated range [min_value, max_value], and an actual value of the sub-counter (next_sub_counter) uploaded to the application server only needs to be the actual number of logins, namely, next_sub_counter=stored_counter+1.

Step S4224: the client terminal acquires a sum of the historical value and a first preset value to obtain the number of logins.

Specifically, as shown in Table 1, for the second application Gmail, the pre-allocated range of the value of sub_counter is (1-100000), the stored stored_sub_counter is 16, and if the user logs in to the application again, then the value of the sub-counter needs to be incremented by 1 (namely, the aforementioned first preset value is 1) and then uploaded to the server, namely, next_sub_counter=16+1=17.

In the aforementioned embodiment of the present disclosure, the first value is a sum of historical values corresponding to all applications installed on the client terminal and the first preset value.

Specifically, the U2F device further needs to upload a total counter value (counter), namely, a counter value stored in the U2F device, to the application server, where the total counter value (counter) is the sum of stored sub-counter values (stored_sub_counter) corresponding to all applications plus 1.

In the aforementioned embodiment of the present disclosure, step S42 in which the client terminal acquires the number of logins includes:

Step S4242: the client terminal acquires a historical mask corresponding to a target application that is sent by the server, where the historical mask is used for representing the number of historical logins of the client terminal logging in to the server.

Specifically, the number of logins may be represented by a “mask” or “Counter reuse” scheme. For example, the user is currently bound to only three websites Facebook, Gmail, and Github, and the shared Counter in the SE has an upper limit of 999999, where Facebook uses the ones and tens (the mask is 0000XX) of the Counter in the SE to constitute a Sub Counter of 0 to 99; Gmail uses the hundreds and thousands (the mask is 00XX00) of the Counter in the SE to constitute a Sub Counter of 0 to 99; Github uses the two highest-order digits (the mask is XX0000) of the Counter in the SE to constitute a Sub Counter of 0 to 99. The mask is stored on the website side, namely, stored in the application server, during registration.

Step S4244: the client terminal acquires a sum of the historical mask and a second preset value to obtain a current mask corresponding to the target application.

Specifically, the aforementioned second preset value may also be 1; each time the user logs in to a specific application, the corresponding application server sends a challenge value including a Counter mask to the U2F for setting, to increase the Counter mask by 1 to obtain a current mask.

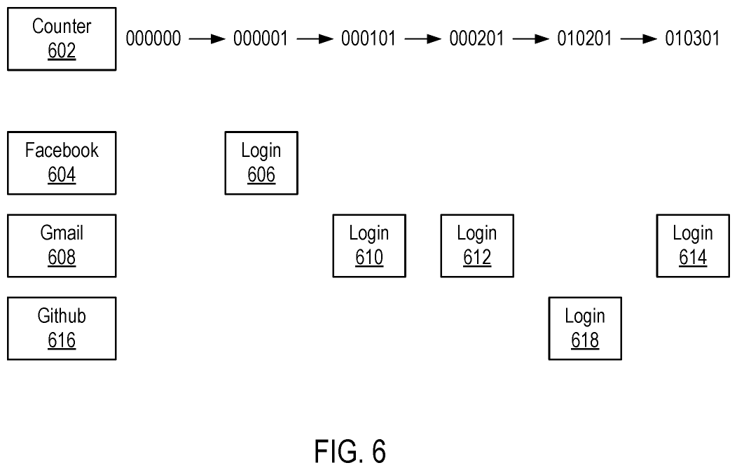

As shown in FIG. 6, when Facebook 604 is logged in to (Login 606), the Counter value 602 is changed from 000000 to 000001; when Gmail 608 is logged in to (Login 610), the Counter value 602 is changed from 000001 to 000101; when Gmail 608 is logged in to again (Login 612), the Counter value 602 is changed from 000101 to 000201; when Github 616 is logged in to (Login 618), the Counter value 602 is changed from 000201 to 010201; when Gmail 608 is logged in to (Login 614), the Counter value 602 is changed from 010201 to 010301.

Step S4246: the client terminal obtains the number of logins based on the current mask.

Specifically, the Sub Counter value may be calculated according to the mask, namely, the number of logins is obtained. For example, as shown in FIG. 6, when Facebook 604 is logged in to (Login 606), it can be determined that the Sub Counter value corresponding to Facebook 604 is 1; when Gmail 608 is logged in to (Login 610), it can be determined that the Sub Counter value corresponding to Gmail 608 is 1; when Gmail 608 is logged in to again (Login 612), it can be determined that the Sub Counter value corresponding to Gmail 608 is 2; when Github 616 is logged in to (Login 618), it can be determined that the Sub Counter value corresponding to Github 616 is 1; when Gmail 608 is logged in to (Login 614), it can be determined that the Sub Counter value corresponding to Gmail 608 is 3.

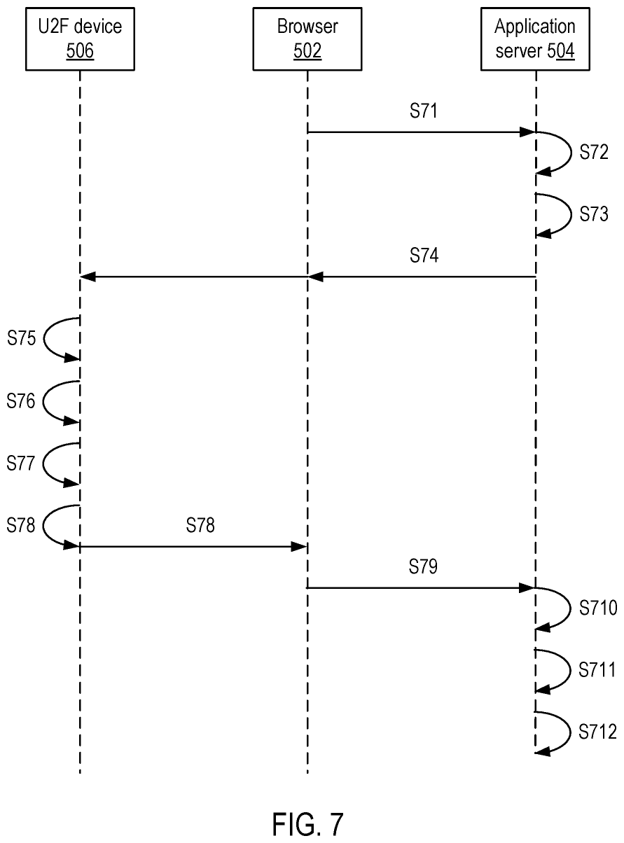

For example, an authentication method based on a mask is shown in FIG. 7. A browser 702 is installed on a client terminal, and the client terminal is connected to a U2F device 706. The method may include the following steps:

The implementation of step S71 to step S73 is the same as that of step S51 to step S53, which will not be described herein again.

Step S74: the application server 504 sends a challenge value including a counter mask to the browser, and sends the challenge value to the U2F device 506 through the browser 502.

The implementation of step S75 is the same as that of step S55, which will not be described herein again.

Step S76: the U2F device 506 increases the counter by 1 based on the mask.

Step S77: the U2F device 506 calculates the value of the subcounter according to the mask.

Step S78: the U2F device 506 signs the challenge value according to its own master key (namely, a private key) and meanwhile generates the value of the counter, generates a response message according to the subcounter value, and sends the response message to the browser 502.

Step S79: the browser 502 forwards the response message to the application server 504.

Step S710: the application server 504 verifies the response message.

Step S711: the application server 504 calculates the value of the subcounter according to the counter and the mask.

Step S712: the application server 504 compares the counter value (counter) that is received this time with an old counter value (counter_old) that is read, and compares the subcounter value sent from the browser 502 with a recorded subcounter value, and if both values are reasonably increased, then it is determined that the two-factor authentication succeeds; otherwise, it is determined that the two-factor authentication fails.

Through the aforementioned solution, the value of a sub-counter determined through a mask is added in authentication information to serve as the number of logins, so that after cloning the master key of the U2F device 506, even if an attacker performs signature verification on a challenge value sent by the application server 504 to generate by himself a large counter value Counter which is larger than a previous one, the attacker cannot learn the number of logins of the user and also cannot pass the verification.

In the aforementioned embodiment of the present disclosure, after step S46 in which the client terminal sends the authentication information to the server, the method further includes:

Step S48: the server verifies the signature information, the first value, and the authentication factor.

Step S410: if the authentication of the signature information, the first value, or the authentication factor fails, then the server rejects the login of the client terminal to the server and executes a corresponding control policy.

Step S412: if the authentication of all the signature information, the first value, and the authentication factor succeeds, then the server allows the client terminal to log in to the server.

In an alternative solution, after the client terminal sends the authentication information to the application server, the application server may perform two-factor authentication to separately authenticate the signature information, the first value, and the authentication factor in the authentication information, where the authentication of the signature information and the first value may be implemented using a method in existing two-factor authentication methods; only if all of the three kinds of information pass the authentication, the application server can allow the client terminal to log in to the server; if only the signature information and the first value pass the authentication, while the authentication factor does not pass the authentication, then it can be determined that cloning exists; namely, after cloning the master key of the U2F device, an attacker generates by himself a large counter value Counter which is greater than a previous one, and since the authentication factor does not pass the authentication, the occurrence of cloning is avoided.

It should be noted that the FIDO U2F standard contains a design for preventing cloning of a counter value Counter, but does not contain many specifications for a Counter anomaly. Different manufacturers do not exercise due control over anti-clone counters of U2F. In theory, a counter exists for these verification devices; namely, the counter is added by 1 upon each use; therefore, the counter will not be decremented, but only incremented. Then, when an attacker acquires the key and logs in, the counter at the server end will be incremented, but a USB key counter of the user himself will not be incremented, so that a counter mismatch occurs when the user uses the USB key next time, so as to generate a warning.

Despite counter detection, existing manufacturers still fail to provide a visible prompt to users for an authentication behavior of a counter mismatch and only show “stalling” once. Some manufacturers even do not perform counter detection. The problem of U2F is not just a hardware problem; the platform also lacks proper protection measures against cloning attacks.

In order to solve the aforementioned problem, the application server may adopt a corresponding control policy when the authentication fails in the two-factor authentication process. Specifically, from the perspective of a website itself that provides U2F as the two-factor authentication service, a new risk control policy is provided; as a third-party review, evaluation and detection organization, an independent auditing method is provided for the website providing U2F as the two-factor authentication service.

In the aforementioned embodiment of the present disclosure, step S48 in which the server authenticates the login time includes:

Step S4802: the server compares a historical login time sent by the client terminal with a locally stored historical login time.

Specifically, for the login time, the application server may receive a current login time sent by the client terminal, and if two-factor authentication succeeds, then the client terminal may be allowed to successfully log in to the application server, so that the current login time may be determined as a login time of this successful login of the client terminal and stored in the application server for next authentication.

Since the historical login time stored in the application server is the login time sent by the client terminal, and the historical login time stored in the client terminal is the same as the historical login time stored in the application server, the application server compares the historical login time sent by the client terminal with the locally stored historical login time. If they are the same, then it can be determined that cloning does not exist in the client terminal; if they are not the same, then it can be determined that cloning exists in the client terminal.

Step S4804: if the historical login time sent by the client terminal is the same as the locally stored historical login time, then the server determines that the authentication of the login time succeeds.

Step S4806: if the historical login time sent by the client terminal is different from the locally stored historical login time, then the server determines that the authentication of the login time fails.

It should be noted that for cloning, since an attacker clones the master key of the U2F device and generates a large counter value Counter, namely, the signature information and the first value in the authentication information both pass the authentication, the two-factor authentication process can be implemented by authenticating the authentication factor in this embodiment of the present disclosure.

In an alternative solution, the application server compares a last successful login time (timestamp_old) sent by the browser with a locally recorded last successful login time (timestamp_last), if the two login times are the same, then it can be determined that the authentication of the login time succeeds, and it is further determined that the two-factor authentication succeeds and no security risks exist; if the two login times are different, then it can be determined that the authentication of the login time fails, and it is further determined that the two-factor authentication fails, security risks exist, and a corresponding risk control policy may be executed.

In the aforementioned embodiment of the present disclosure, after the server determines that the authentication of the login time succeeds, the client terminal updates, according to a current login time, a historical login time stored in the authentication device; and the server updates the locally stored historical login time according to the current login time.

Specifically, after the application server determines that the authentication of the login time sent by the client terminal succeeds, it can be determined that no cloning risks exist; in order to implement next two-factor authentication, the client terminal may store the current login time in the single-chip microcomputer of the U2F device to serve as a historical login time to be acquired next time; the application server may also store the current login time in a local device to serve as a historical login time to be acquired next time.

It should be noted that to avoid storage of an excessively large amount of data, the client terminal and the application server can both adopt an overwriting storage manner to store the current login time.

In the aforementioned embodiment of the present disclosure, step S48 in which the server authenticates the number of logins includes:

Step S4822: the server acquires a locally stored historical value of a sub-counter corresponding to a target application to obtain the locally stored number of historical logins.

Specifically, the client terminal and the application server may store a historical value of a sub-counter and not just the number of historical logins. The application server may store only a historical value of a sub-counter corresponding to a corresponding target application without storing historical values of sub-counters corresponding to other applications, while the client terminal may store historical values of sub-counters corresponding to all installed applications.

Step S4824: the server acquires a difference between the number of logins sent by the client terminal and the locally stored number of historical logins.

Step S4826: the server judges whether the difference is a first preset value.

Step S4828: if the difference is the first preset value, then the server determines that the authentication of the number of logins succeeds.

Step S4830: if the difference is not the first preset value, then the server determines that the authentication of the number of logins fails.

Specifically, since the number of logins sent by the client terminal is obtained by adding 1 to the number of historical logins, after receiving the number of logins sent by the client terminal, the application server may perform comparison to see whether a difference between the number of logins and the locally stored number of historical logins is 1. If the difference is 1, then it can be determined that no security risks exist so as to determine that the authentication of the number of logins succeeds, and it is further determined that the two-factor authentication succeeds and no security risks exist; if the difference is not 1, then it can be determined that security risks exist so as to determine that the authentication of the number of logins fails, and it is further determined that the two-factor authentication fails and a corresponding risk control policy may be executed.

In the aforementioned embodiment of the present disclosure, after the server determines that the authentication of the number of logins succeeds, the client terminal updates a historical value stored in the authentication device according to the number of logins; and the server updates the locally stored historical value according to the number of logins.

Specifically, after the application server determines that the authentication of the number of logins sent by the client terminal succeeds, it can be determined that no cloning risks exist; in order to implement next two-factor authentication, the client terminal may determine a current value of the sub-counter according to the number of logins and store the current value in the single-chip microcomputer of the U2F device to serve as a historical value to be acquired next time; the application server may also store the current value in a local device to serve as a historical value to be acquired next time.

In the aforementioned embodiment of the present disclosure, step S48 in which the server authenticates the number of logins includes:

Step S4842: the server acquires a locally stored historical mask corresponding to a target application.

Specifically, the mask may be stored on a website side, namely, a historical mask is stored in the application server and may be updated according to the number of logins sent by the client terminal so as to realize update of the mask.

Step S4844: the server obtains the locally stored number of historical logins according to the locally stored historical mask and the first value.

Step S4846: the server judges whether a difference between the number of logins and the locally stored number of historical logins is a first preset value.

Step S4848: if the difference is the first preset value, then the server determines that the authentication of the number of logins succeeds.

Step S4850: if the difference is not the first preset value, then the server determines that the authentication of the number of logins fails.

Specifically, since the number of logins sent by the client terminal is obtained by adding 1 to the number of historical logins, comparison may also be performed to see whether a difference between the number of logins and the locally stored number of historical logins is 1 so as to determine whether the authentication of the number of logins succeeds, and it is further determined whether the two-factor authentication succeeds.

In the aforementioned embodiment of the present disclosure, after step S4848 in which the server determines that the authentication of the number of logins succeeds, the method further includes:

Step S4852: the server acquires a sum of the historical mask and a second preset value to obtain a current mask corresponding to the target application.

Specifically, since the difference between the number of logins received by the application server and the number of historical logins is 1, the application server may increase the locally stored historical mask by 1 to obtain a current mask and use it as a historical mask in the next two-factor authentication process.

Step S4854: the server updates the locally stored historical mask according to the current mask.

Specifically, after the two-factor authentication succeeds, the application server may locally store the calculated current mask in an overwriting manner, so that the application server sends the locally stored historical mask while sending a challenge value in the next two-factor process.

In the aforementioned embodiment of the present disclosure, step S48 in which the server authenticates the first value includes:

Step S4862: the server acquires a difference between a first value sent by the client terminal and a locally stored first value.

Step S4864: the server judges whether the difference is within a preset range.

Step S4866: if the difference is within the preset range, then the server determines that the authentication of the first value succeeds.

Step S4868: if the difference is not within the preset range, then the server determines that the authentication of the first value fails.

Specifically, if no cloning exists, then the application server can determine that a difference between a counter value (counter) that is sent by the client terminal and an old counter value (counter_old) that is read is 1; if cloning exists, namely, the counter value sent by the client terminal is generated by an attacker himself, then the counter value may be less than a counter value (counter_old) stored in the application server, and the counter value may also be far larger than a locally stored counter value (counter_old). Therefore, a preset range may be preset, and if the difference between two counter values is not within the preset range, then it can be determined that cloning exists.

In the aforementioned embodiment of the present disclosure, in the case that the authentication of the first value fails, step S410 in which the server executes a corresponding control policy includes:

Step S4102: if the difference is less than a minimum of the preset range, then the server executes a rollback control policy.

Step S4104: if the difference is larger than a maximum of the preset range, then the server executes a jump control policy.

Step S4106: if the first value sent by the client terminal exceeds a storage space of the server, then the server executes an overflow control policy.

Specifically, the present disclosure provides a risk control policy for a website itself of a two-factor authentication service, and provides an independent auditing method as a third-party review, evaluation and detection organization, which mainly includes three kinds of risk detection and control, namely, a rollback control policy Counter Rolling Back, a jump control policy Counter Jump, and an overflow control policy Counter Overflow, as shown in the following Table 2:

TABLE 2

| | | | | Security evaluation |
|---|---|---|---|---|
| | | | New risk control | means of the third |
| | | | policy for the | party for the |
| Serial | | | application server | application server |
| number | Risk item | Description | (website) | (website) |
| 1 | Counter | Authenticate that | Upon discovering | Use a U2F protocol |
| | Rolling | an uploaded Counter | this behavior, | simulator to create |
| | Back | value is less than | directly revoke | a Rolling Back |
| | | a Counter maximum | the U2F | behavior and observe |
| | | recorded by the | authentication | the behavior |
| | | website | factor | |
| 2 | Counter | Increase by a | For this behavior, | Use the U2F protocol |
| | Jump | relatively large | generate an alarm: | simulator to create a |
| | | value in a | email alert, and | Counter Jump behavior |
| | | relatively short | temporarily revoke | |
| | | period of time | the U2F factor | |
| 3 | Counter | The value of the | Upon detecting an | Use the U2F protocol |
| | Overflow | Counter transmitted | overflow, the | simulator to construct |
| | | to the website side | application server | a large Counter and |
| | | exceeds the storage | may revoke the | observe its behavior |
| | | space and overflows | authentication | |
| | | | factor and allow | |
| | | | the user to be | |
| | | | rebound to a new | |
| | | | U2F device | |

For Counter Rolling Back, the application server compares a received Counter value with a Counter maximum recorded by the website, and finds that the received Counter value is less than the previously recorded Counter maximum. For example, the last maximum is 99, and the value received this time is 50. Upon discovering this behavior, the website directly revokes the U2F authentication factor using a new risk control policy. In addition, the independent detection party may use a U2F protocol simulator to create a Rolling Back behavior and observe the behavior. Security evaluation and recommendations may be provided to the website according to the corresponding risk control response (not detecting the Counter at all/detecting the Counter but not generating an alarm/generating an alarm but not revoking) of the website.

For Counter Jump, the application server compares a received Counter value with the Counter maximum recorded by the website to see a big jump. For example, the previously recorded Counter value is 99, while the Counter value jumps to 199 this time. Upon discovering this behavior, the website adopts a new risk control policy to restrain the value from increasing by a relatively large value (for example, 1000) in a relatively short period of time (for example, one month), generate an alarm (email alert or short message service alert) for this behavior, and further temporarily revoke the U2F factor. The user may be authenticated in other manners to enable the U2F authentication factor again.

For Counter Overflow, the Counter value received by the application server exceeds the storage space and overflows. For example, Counter is of four bytes, and has an overflow upper bound of generally 4294967296, and if the Counter value received by the website is larger than the upper bound, then the Counter value overflows. Upon detecting an overflow, the website should revoke the authentication factor and allow the user to be rebound to a new U2F device. The upper bound is difficult to reach under normal use. An overflow is more likely to be reached due to hacking. The solution is essentially to sacrifice a little user experience for security.

In the aforementioned embodiment of the present disclosure, step S48 in which the server authenticates the signature information includes:

Step S4882: the server authenticates the signature information through a locally stored public key.

Specifically, the public key stored locally in the application server may be a public key corresponding to a user account that is sent by the U2F device during registration.

In the aforementioned embodiment of the present disclosure, in the case that the authentication of the authentication factor fails, step S410 in which the server executes a corresponding control policy includes at least one of the following:

Step S4108: the server rejects the login of the client terminal.

Step S4110: the server authenticates the client terminal again.

Step S4112: the server revokes the authentication factor.

In an alternative solution, if the application server determines that the authentication of the authentication factor fails, then the application server may warn the user of risks and reject the login of the client terminal to the application server, allow the user to perform secondary confirmation, or revoke the U2F authentication factor.

In the aforementioned embodiment of the present disclosure, the method further includes:

Step S414: the client terminal encrypts the authentication information to obtain encrypted authentication information.

Step S416: the client terminal sends the encrypted authentication information to the server.

Specifically, in scenarios requiring privacy protection and prevention of a middle-man attack, the authentication information, such as the signature information, the counter value, and the authentication factor, uploaded by the browser needs to be encrypted and then sent to the server so as to protect user privacy and prevent a middle-man attack.

In the aforementioned embodiment of the present disclosure, after step S46 in which the client terminal sends the authentication information to the server, the method further includes:

Step S418: the server acquires a digital certificate of an authentication device installed on the client terminal.

Step S420: the server performs matching between the digital certificate and a certificate whitelist.

Step S422: if the matching between the digital certificate and the certificate whitelist fails, then the server executes an authentication device control policy.

Specifically, the user has certain security risks when using a U2F device produced by the user himself or produced by small manufacturers. In the current U2F standard, a digital certificate Attestation Key is used, where a manufacturer of a U2F device is verified through a digital certificate of the U2F device manufacturer, but the standard does not enforce a risk control policy for the Attestation Key. In this embodiment of the present disclosure, a whitelist of the U2F device Attestation Key is added in the application server; namely, digital certificates of U2F device manufacturers are verified, and only U2F device manufacturers recognized in the whitelist are accepted. Through the aforementioned solution, a tolerance policy of the website for DIY devices can be detected.

In the aforementioned embodiment of the present disclosure, before step S42 in which the client terminal acquires signature information, a first value of a preset counter, and an authentication factor, the method further includes:

Step S424: the client terminal sends a login request carrying a login account and a login password to the server, where the login request is verified by the server.

Step S426: in the case that the verification of the login request succeeds, the client terminal receives the challenge value and/or a historical mask corresponding to a target application that is sent by the server.

In an alternative solution, when two-factor authentication needs to be performed, a user may log in to an application through the browser; the browser sends to the application server a user account and a password that are entered by the user, and the application server performs verification; if the user account and the password pass the verification, then the application server may generate a challenge value and send the challenge value to the U2F device through the browser. In the case that the authentication factor adopts a mask, the application server may send the locally stored historical mask corresponding to the application while sending the challenge value.

It should be noted that in order to briefly describe each foregoing method embodiment, all the method embodiments are expressed as a combination of a series of actions, but those skilled in the art should know that the present disclosure is not limited by the sequence of the described actions because certain steps can be applied with different sequences or can be carried out at the same time according to the present disclosure. Secondly, those skilled in the art should also know that all the embodiments described in the description belong to preferred embodiments; the related actions and modules are not necessarily needed for the present disclosure.

Through the description of the embodiments, those skilled in the art can clearly understand that the method according to the embodiments can be implemented by means of software plus a necessary general hardware platform. Certainly, the hardware can also be used, but the former is a better implementation in many cases. Based on such understanding, the essence of the technical solutions of the present disclosure or the part that makes contributions to the prior art may be embodied in the form of a software product. The computer software product is stored in a storage medium (for example, a ROM/RAM, a magnetic disk, or an optical disc) and includes several instructions for instructing a terminal device (which may be a mobile phone, a computer, a server, a network device, or the like) to perform the methods described in the embodiments of the present disclosure.

### Embodiment 2

According to this embodiment of the present disclosure, an embodiment of an authentication method is further provided. It should be noted that the steps shown in the flowchart of the drawings may be performed in a computer system such as a set of computer-executable instructions. Although a logical order is shown in the flowchart, in some cases, the illustrated or described steps may be performed in a different order other than the one shown here.

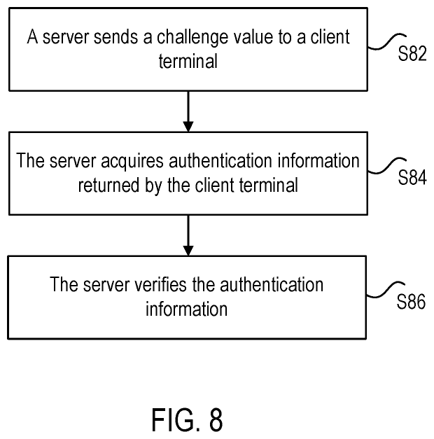

FIG. 8 is a flowchart of an authentication method according to Embodiment 2 of the present disclosure. As shown in FIG. 8, the method includes the following steps:

Step S82: a server sends a challenge value to a client terminal.

Optionally, the client terminal may be connected to an authentication device, and an authentication factor may be stored in a single-chip microcomputer or a secure element of the authentication device.

Specifically, the aforementioned client terminal may be a computer terminal, the aforementioned server may be an application server, and the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value of the preset counter).

In an alternative solution, when two-factor authentication needs to be performed, a user may log in to an application through the browser; the browser sends to the application server a user account and a password that are entered by the user, and the application server performs verification; if the user account and the password pass the verification, then the application server may generate a challenge value and send the challenge value to the U2F device through the browser.

Step S84: the server acquires authentication information returned by the client terminal where the authentication information is generated based on signature information, a first value of a preset counter, and an authentication factor; the signature information is obtained by signing the challenge value, the first value is used for representing the number of operations of signing the challenge value; and the authentication factor is used for representing login information of the client terminal logging in to the server.

Optionally, the authentication factor may include at least one of the following: a login time and the number of logins.

Since it is impossible to detect the occurrence of cloning in all cases, in order to avoid the occurrence of cloning, an authentication factor that cannot be learned by an attacker may be added, which may be, for example, login information of the client terminal logging in to the application server last time and may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal, or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed, except that a new authentication factor is added in the single-chip microcomputer, so that no new security risks are introduced. When the SE has a large storage capacity, the authentication factor may be stored in the SE in order to increase security.

Step S86: the server verifies the authentication information.

In an alternative solution, in the two-factor authentication process, the application server may send a challenge value to the client terminal; the client terminal uses the U2F device to sign the challenge value according to its own master key (namely, a private key) to obtain signature information and meanwhile generate the value of a counter, read a newly added authentication factor, further generate authentication information according to the aforementioned information, and forward the authentication information to the application server through the browser for two-factor authentication. After receiving the authentication information, the application server needs to separately verify the signature information, the value of the counter, and the authentication factor, and can determine that the two-factor authentication succeeds only when all the information passes the verification.

In the solution provided in Embodiment 2 of the present disclosure, the server sends a challenge value to the client terminal, acquires authentication information returned by the client terminal, and verifies the authentication information, so as to achieve the purpose of Universal 2nd Factor authentication.

It is noted that the authentication information not only includes the signature information and the first value of the preset counter, but also includes the authentication factor, and the authentication factor is login information of the client terminal logging in to the server. As compared with the prior art, since an attacker cannot learn the authentication factor, the attacker cannot pass the two-factor authentication even if the attacker generates a large counter value; thus, the occurrence of a cloning operation can be effectively detected, and the technical effect of enhancing authentication accuracy and improving user experience can be achieved.

Accordingly, the solution of Embodiment 2 provided in the present disclosure solves the technical problem of low authentication accuracy caused by failure to effectively detect the occurrence of a cloning operation in authentication methods in the prior art.

In the aforementioned embodiment of the present disclosure, step S86 in which the server verifies the authentication information includes:

Step S88: the server verifies the signature information, the first value, and the authentication factor.

Step S810: if the authentication of the signature information, the first value, or the authentication factor fails, then the server rejects the login of the client terminal to the server and executes a corresponding control policy.

Step S812: if the authentication of all the signature information, the first value, and the authentication factor succeeds, then the server allows the client terminal to log in to the server.

In an alternative solution, after the client terminal sends the authentication information to the application server, the application server may perform two-factor authentication to separately authenticate the signature information, the first value, and the authentication factor in the authentication information, where the authentication of the signature information and the first value may be implemented using a method in existing two-factor authentication methods; only if all of the three kinds of information pass the authentication, the application server can allow the client terminal to log in to the server; if only the signature information and the first value pass the authentication but the authentication factor does not pass the authentication, then it can be determined that cloning exists; namely, after cloning the master key of the U2F device, an attacker generates by himself a large counter value Counter which is greater than a previous one, and since the authentication factor does not pass the authentication, the occurrence of cloning is avoided.

It should be noted that the FIDO U2F standard contains a design for preventing cloning of a counter value Counter, but does not contain many specifications for a Counter anomaly. Different manufacturers do not exercise due control over anti-clone counters of U2F. In theory, a counter exists for these verification devices; namely, the counter is added by 1 upon each use; therefore, the counter will not be decremented, but only incremented. Then, when an attacker acquires the key and logs in, the counter at the server end will be incremented, but a USB key counter of the user himself will not be incremented, so that a counter mismatch occurs when the user uses the USB key next time, so as to generate a warning.

Despite counter detection, existing manufacturers still fail to provide a visible prompt to users for an authentication behavior of a counter mismatch and only show “stalling” once. Some manufacturers even do not perform counter detection. The problem of U2F is not just a hardware problem; the platform also lacks proper protection measures against cloning attacks.

In order to solve the aforementioned problem, the application server may adopt a corresponding control policy when the authentication fails in the two-factor authentication process. Specifically, from the perspective of a website itself that provides U2F as the two-factor authentication service, a new risk control policy is provided; as a third-party review, evaluation and detection organization, an independent auditing method is provided for the website providing U2F as the two-factor authentication service.

In the aforementioned embodiment of the present disclosure, the authenticating, by the server, the login time includes: comparing, by the server, a historical login time sent by the client terminal with a locally stored historical login time; if the historical login time sent by the client terminal is the same as the locally stored historical login time, then determining, by the server, that the authentication of the login time succeeds; and if the historical login time sent by the client terminal is different from the locally stored historical login time, then determining, by the server, that the authentication of the login time fails.

In the aforementioned embodiment of the present disclosure, after the server determines that the authentication of the login time succeeds, the server updates the locally stored historical login time according to a current login time.

In the aforementioned embodiment of the present disclosure, the authenticating, by the server, the number of logins includes: acquiring, by the server, a locally stored historical value of a sub-counter corresponding to a target application to obtain the locally stored number of historical logins; acquiring, by the server, a difference between the number of logins sent by the client terminal and the locally stored number of historical logins; judging, by the server, whether the difference is a first preset value; if the difference is the first preset value, then determining, by the server, that the authentication of the number of logins succeeds; and if the difference is not the first preset value, then determining, by the server, that the authentication of the number of logins fails.

In the aforementioned embodiment of the present disclosure, after the server determines that the authentication of the number of logins succeeds, the server updates the locally stored historical value according to the number of logins.

In the aforementioned embodiment of the present disclosure, the authenticating, by the server, the number of logins includes: acquiring, by the server, a locally stored historical mask corresponding to a target application; obtaining, by the server, the locally stored number of historical logins according to the locally stored historical mask and the first value; judging, by the server, whether a difference between the number of logins and the locally stored number of historical logins is a first preset value; if the difference is the first preset value, then determining, by the server, that the authentication of the number of logins succeeds; and if the difference is not the first preset value, then determining, by the server, that the authentication of the number of logins fails.

In the aforementioned embodiment of the present disclosure, after the server determines that the authentication of the number of logins succeeds, the method further includes: acquiring, by the server, a sum of the historical mask and a second preset value to obtain a current mask corresponding to the target application; and updating, by the server, the locally stored historical mask according to the current mask.

In the aforementioned embodiment of the present disclosure, the authenticating, by the server, the first value includes: acquiring, by the server, a difference between a first value sent by the client terminal and a locally stored first value; judging, by the server, whether the difference is within a preset range; if the difference is within the preset range, then determining, by the server, that the authentication of the first value succeeds; and if the difference is not within the preset range, then determining, by the server, that the authentication of the first value fails.

In the aforementioned embodiment of the present disclosure, in the case that the authentication of the first value fails, the executing, by the server, a corresponding control policy includes: if the difference is less than a minimum of the preset range, then executing, by the server, a rollback control policy; if the difference is larger than a maximum of the preset range, executing, by the server, a jump control policy; and if the first value sent by the client terminal exceeds a storage space of the server, then executing, by the server, an overflow control policy.

In the aforementioned embodiment of the present disclosure, the authenticating, by the server, the signature information includes: authenticating, by the server, the signature information through a locally stored public key.

In the aforementioned embodiment of the present disclosure, in the case that the authentication of the authentication factor fails, the executing, by the server, a corresponding control policy includes at least one of the following: rejecting, by the server, the login of the client terminal; authenticating, by the server, the client terminal again; and revoking, by the server, the authentication factor.

In the aforementioned embodiment of the present disclosure, the method further includes: receiving, by the server, encrypted authentication information sent by the client terminal, where the encrypted authentication information is obtained by encrypting the authentication information by the client terminal.

In the aforementioned embodiment of the present disclosure, after the server acquires the authentication information returned by the client terminal, the method further includes: acquiring, by the server, a digital certificate of an authentication device installed on the client terminal; performing, by the server, matching between the digital certificate and a certificate whitelist; and if the matching between the digital certificate and the certificate whitelist fails, then executing, by the server, an authentication device control policy.

In the aforementioned embodiment of the present disclosure, before the server sends the challenge value to the client terminal, the method further includes: receiving, by the server, a login request that is sent by the client terminal and carries a login account and a login password; verifying, by the server, the login request; and in the case that the verification of the login request succeeds, sending, by the server, the challenge value and/or a historical mask corresponding to a target application to the client terminal.

### Embodiment 3

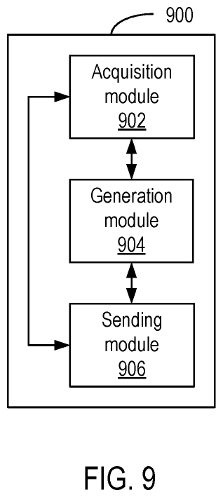

According to this embodiment of the present disclosure, an authentication apparatus for implementing the aforementioned authentication method is further provided, where the apparatus is deployed on a client terminal side. As shown in FIG. 9, the apparatus 900 includes an acquisition module 902, a generation module 904, and a sending module 906.

The acquisition module 902 is configured to acquire signature information, a first value of a preset counter, and an authentication factor, where the signature information is obtained by signing a challenge value sent by a server, the first value is used for representing the number of operations of signing the challenge value, and the authentication factor is used for representing login information of the client terminal logging in to the server; the generation module 904 is configured to generate authentication information based on the signature information, the first value, and the authentication factor; and the sending module 906 is configured to send the authentication information to the server, where the server verifies the authentication information.

Optionally, the client terminal may be connected to an authentication device, and an authentication factor may be stored in a single-chip microcomputer or a secure element of the authentication device.

Optionally, the authentication factor may include at least one of the following: a login time and the number of logins.

Specifically, the aforementioned client terminal may be a computer terminal, the aforementioned server may be an application server, and the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value of the preset counter).

Since it is impossible to detect the occurrence of cloning in all cases, in order to avoid the occurrence of cloning, an authentication factor that cannot be learned by an attacker may be added, which may be, for example, login information of the client terminal logging in to the application server last time and may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal, or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed except that a new authentication factor is added in the single-chip microcomputer, so that no new security risks are introduced. When the SE has a large storage capacity, the authentication factor may be stored in the SE in order to increase security.

It should be noted here that the acquisition module 902, the generation module 904, and the sending module 906 correspond to step S42 to step S46 in Embodiment 1. Examples and application scenarios for implementation of the three modules are the same as those of the corresponding steps, but are not limited to the content disclosed in Embodiment 1. It should be noted that as part of the apparatus, the aforementioned modules may operate in the computer terminal 20 provided in Embodiment 1.

In the solution provided in Embodiment 3 of the present disclosure, the client terminal acquires signature information, a first value of a preset counter, and an authentication factor through the acquisition module; further generates authentication information according to the acquired information through the generation module; and sends the authentication information to the server through the sending module for verification, so as to achieve the purpose of Universal 2nd Factor authentication.

It is noted that the authentication information not only includes the signature information and the first value of the preset counter, but also includes the authentication factor, and the authentication factor is login information of the client terminal logging in to the server. As compared with the prior art, since an attacker cannot learn the authentication factor, the attacker cannot pass the two-factor authentication even if the attacker generates a large counter value; thus, the occurrence of a cloning operation can be effectively detected, and the technical effect of enhancing authentication accuracy and improving user experience can be achieved.

Accordingly, the solution of Embodiment 3 provided in the present disclosure solves the technical problem of low authentication accuracy caused by failure to effectively detect the occurrence of a cloning operation in authentication methods in the prior art.

In the aforementioned embodiment of the present disclosure, the acquisition module includes: a first reading unit, configured to read a historical login time from the authentication device, where the historical login time is used for representing a login time of the client terminal successfully logging in to the server last time; and a second reading unit, configured to read a current login time, where the current login time is used for representing a login time of the client terminal currently logging in to the server.

Optionally, in the case that the client terminal logs in to the server for the first time, the historical login time is used for representing a time of performing a registration operation on the server by the client terminal, where in the case that the client terminal performs the registration operation on the server, the client terminal generates the login time according to the current login time.

In the aforementioned embodiment of the present disclosure, the acquisition module includes: a third reading unit, configured to read a historical value of a sub-counter corresponding to a target application from the authentication device, where the target application corresponds to the server, and the historical value of the sub-counter is used for representing the number of historical logins of the client terminal logging in to the server; and a first acquisition unit, configured to acquire a sum of the historical value and a first preset value to obtain the number of logins.

In the aforementioned embodiment of the present disclosure, the first value of the preset counter is a sum of historical values of sub-counters corresponding to all applications installed on the client terminal and the first preset value.

In the aforementioned embodiment of the present disclosure, the acquisition module includes: a second acquisition unit, configured to acquire a historical mask corresponding to a target application that is sent by the server, where the historical mask is used for representing the number of historical logins of the client terminal logging in to the server; a third acquisition unit, configured to acquire a sum of the historical mask and a second preset value to obtain a current mask corresponding to the target application; and a processing unit, configured to obtain the number of logins based on the current mask.

In the aforementioned embodiment of the present disclosure, the apparatus further includes a storage module, configured to, after the server determines that the authentication of the login time succeeds, update the historical login time stored in the authentication device according to a current login time.

In the aforementioned embodiment of the present disclosure, the storage module is further configured to, after the server determines that the authentication of the number of logins succeeds, update the historical value stored in the authentication device according to the number of logins.

In the aforementioned embodiment of the present disclosure, the apparatus further includes an encryption module configured to encrypt, by the client terminal, the authentication information to obtain encrypted authentication information, and the sending module is further configured to send the encrypted authentication information to the server.

In the aforementioned embodiment of the present disclosure, the sending module is further configured to send a login request carrying a login account and a login password to the server, where the login request is verified by the server; and the apparatus further includes a receiving module configured to, in the case that the verification of the login request succeeds, receive the challenge value and/or a historical mask corresponding to a target application that is sent by the server.

### Embodiment 4

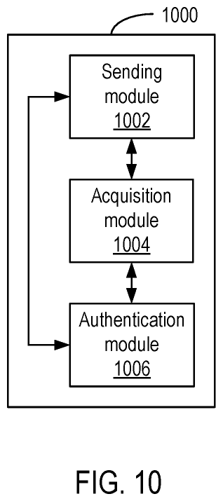

According to this embodiment of the present disclosure, an authentication apparatus for implementing the aforementioned authentication method is further provided, where the apparatus is deployed on a server side. As shown in FIG. 10, the apparatus 1000 includes a sending module 1002, an acquisition module 1004, and an authentication module 1006.

The sending module 1002 is configured to send a challenge value to a client terminal; the acquisition module 1004 is configured to acquire authentication information returned by the client terminal, where the authentication information is generated based on signature information, a first value of a preset counter, and an authentication factor; the signature information is obtained by signing the challenge value, the first value is used for representing the number of operations of signing the challenge value, and the authentication factor is used for representing login information of the client terminal logging in to the server; and the authentication module 1006 is configured to verify the authentication information.

Optionally, the client terminal may be connected to an authentication device, and an authentication factor may be stored in a single-chip microcomputer or a secure element of the authentication device.

Specifically, the aforementioned client terminal may be a computer terminal, the aforementioned server may be an application server, and the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value of the preset counter).

Optionally, the authentication factor may include at least one of the following: a login time and the number of logins.

Since it is impossible to detect the occurrence of cloning in all cases, in order to avoid the occurrence of cloning, an authentication factor that cannot be learned by an attacker may be added, which may be, for example, login information of the client terminal logging in to the application server last time and may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal, or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed, except that a new authentication factor is added in the single-chip microcomputer, so that no new security risks are introduced. When the SE has a large storage capacity, the authentication factor may be stored in the SE in order to increase security.

It should be noted here that the sending module 1002, the acquisition module 1004, and the authentication module 1006 correspond to step S82 to step S86 in Embodiment 2. Examples and application scenarios for implementation of the three modules are the same as those of the corresponding steps, but are not limited to the content disclosed in Embodiment 2. It should be noted that as part of the apparatus, the aforementioned modules may operate in the computer terminal 20 provided in Embodiment 1.

In the solution provided in Embodiment 4 of the present disclosure, the server sends a challenge value to the client terminal through the sending module; acquires, through the acquisition module, authentication information returned by the client terminal; and verifies the authentication information through the authentication module, so as to achieve the purpose of Universal 2nd Factor authentication.

It is noted that the authentication information not only includes the signature information and the first value of the preset counter, but also includes the authentication factor, and the authentication factor is login information of the client terminal logging in to the server. As compared with the prior art, since an attacker cannot learn the authentication factor, the attacker cannot pass the two-factor authentication even if the attacker generates a large counter value; thus, the occurrence of a cloning operation can be effectively detected, and the technical effect of enhancing authentication accuracy and improving user experience can be achieved.

Accordingly, the solution of Embodiment 4 provided in the present disclosure solves the technical problem of low authentication accuracy caused by failure to effectively detect the occurrence of a cloning operation in authentication methods in the prior art.

In the aforementioned embodiment of the present disclosure, the authentication module includes: an authentication unit configured to verify the signature information, the first value, and the authentication factor; a first processing unit, configured to, if the authentication of the signature information, the first value, or the authentication factor fails, reject the login of the client terminal to the server and execute a corresponding control policy; and a second processing unit, configured to, if the authentication of all the signature information, the first value, and the authentication factor succeeds, allow the client terminal to log in to the server.

In the aforementioned embodiment of the present disclosure, the authentication unit includes: a comparison sub-module, configured to compare a historical login time sent by the client terminal with a locally stored historical login time; and a first determining sub-module, configured to, if the historical login time sent by the client terminal is the same as the locally stored historical login time, determine that the authentication of the login time succeeds, and configured to, if the historical login time sent by the client terminal is different from the locally stored historical login time, determine, by the server, that the authentication of the login time fails.

In the aforementioned embodiment of the present disclosure, the apparatus further includes a storage module configured to, after the server determines that the authentication of the login time succeeds, update the locally stored historical login time according to a current login time.

In the aforementioned embodiment of the present disclosure, the authentication unit includes: a first acquisition sub-module, configured to acquire a locally stored historical value of a sub-counter corresponding to a target application to obtain the locally stored number of historical logins; a second acquisition sub-module, configured to acquire a difference between the number of logins sent by the client terminal and the locally stored number of historical logins; a first judgment sub-module, configured to judge whether the difference is a first preset value; and a second determining sub-module, configured to, if the difference is the first preset value, determine that the authentication of the number of logins succeeds, and configured to, if the difference is not the first preset value, determine that the authentication of the number of logins fails.

In the aforementioned embodiment of the present disclosure, the storage module is further configured to, after the server determines that the authentication of the number of logins succeeds, update the locally stored historical value according to the number of logins.

In the aforementioned embodiment of the present disclosure, the authentication unit includes: a third acquisition sub-module, configured to acquire a locally stored historical mask corresponding to a target application; a processing sub-module, configured to obtain the locally stored number of historical logins according to the locally stored historical mask and the first value; a second judgment sub-module, configured to judge whether a difference between the number of logins and the locally stored number of historical logins is a first preset value; and a third determining sub-module, configured to, if the difference is the first preset value, determine that the authentication of the number of logins succeeds, and configured to, if the difference is not the first preset value, determine that the authentication of the number of logins fails.

In the aforementioned embodiment of the present disclosure, the storage module is further configured to acquire a sum of the historical mask and a second preset value to obtain a current mask corresponding to the target application, and update the locally stored historical mask according to the current mask.

In the aforementioned embodiment of the present disclosure, the authentication unit includes: a fourth acquisition sub-module, configured to acquire a difference between a first value sent by the client terminal and a locally stored first value; a third judgment sub-module, configured to judge whether the difference is within a preset range; and a fourth determining sub-module, configured to, if the difference is within the preset range, determine that the authentication of the first value succeeds, and configured to, if the difference is not within the preset range, determine that the authentication of the first value fails.

In the aforementioned embodiment of the present disclosure, the first processing unit includes: a first execution sub-module, configured to, if the difference is less than a minimum of the preset range, execute a rollback control policy; a second execution sub-module, configured to, if the difference is larger than a maximum of the preset range, execute a jump control policy; and a third execution sub-module, configured to, if the first value sent by the client terminal exceeds a storage space of the server, execute an overflow control policy.

In the aforementioned embodiment of the present disclosure, the authentication unit includes: an authentication sub-module, configured to authenticate, by the server, the signature information through a locally stored public key.

In the aforementioned embodiment of the present disclosure, the first processing unit includes at least one of the following: a rejection sub-module, configured to reject the login of the client terminal; a secondary authentication sub-module, configured to authenticate the client terminal again; and a revoking sub-module, configured to revoke the authentication factor.

In the aforementioned embodiment of the present disclosure, the apparatus further includes: a receiving module, configured to receive encrypted authentication information sent by the client terminal, where the encrypted authentication information is obtained by encrypting the authentication information by the client terminal.

In the aforementioned embodiment of the present disclosure, the acquisition module is configured to acquire a digital certificate of an authentication device installed on the client terminal; the apparatus further includes: a matching module, configured to perform matching between the digital certificate and a certificate whitelist; and an execution module, configured to, if the matching between the digital certificate and the certificate whitelist fails, execute an authentication device control policy.

In the aforementioned embodiment of the present disclosure, the apparatus further includes: a receiving module, configured to receive a login request that is sent by the client terminal and carries a login account and a login password; a verification module, configured to verify the login request; and the sending module is further configured to, in the case that the verification of the login request succeeds, send the challenge value and/or a historical mask corresponding to a target application to the client terminal.

### Embodiment 5

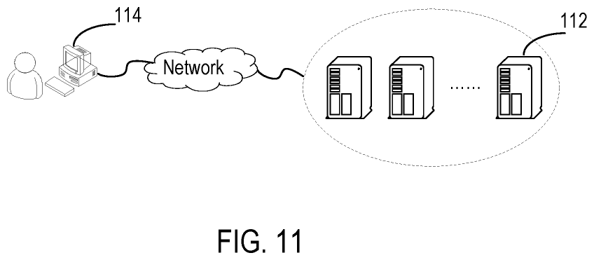

According to this embodiment of the present disclosure, an authentication system is further provided. As shown in FIG. 11, the system includes:

a server 112, configured to send a challenge value; and a client terminal 114, having a communication relationship with the server 112, and configured to generate authentication information based on signature information, a first value of a preset counter, and an authentication factor, where the signature information is obtained by signing the challenge value, the first value is used for representing the number of operations of signing the challenge value, and the authentication factor includes one of the following: a login time and a second value of a sub-counter corresponding to a target application; and the server 112 is further configured to verify the authentication information to obtain an authentication result.

Optionally, the client terminal 114 may be connected to an authentication device, and an authentication factor may be stored in a single-chip microcomputer or a secure element of the authentication device.

Optionally, the authentication factor may include at least one of the following: a login time and the number of logins.

Specifically, the aforementioned client terminal may be a computer terminal, the aforementioned server may be an application server, and the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value of the preset counter).

Since it is impossible to detect the occurrence of cloning in all cases, in order to avoid the occurrence of cloning, an authentication factor that cannot be learned by an attacker may be added, which may be, for example, login information of the client terminal logging in to the application server last time and may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal, or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed, except that a new authentication factor is added in the single-chip microcomputer, so that no new security risks are introduced. When the SE has a large storage capacity, the authentication factor may be stored in the SE in order to increase security.

In an alternative solution, in the two-factor authentication process, the application server may send a challenge value to the client terminal; the client terminal uses the U2F device to sign the challenge value according to its own master key (namely, a private key) to obtain signature information and meanwhile generate the value of a counter, read a newly added authentication factor, further generate authentication information according to the aforementioned information, and forward the authentication information to the application server through the browser for two-factor authentication. After receiving the authentication information, the application server needs to separately verify the signature information, the value of the counter, and the authentication factor, and can determine that the two-factor authentication succeeds only when all the information passes the verification.

In the solution provided in Embodiment 5 of the present disclosure, the client terminal acquires signature information, a first value of a preset counter, and an authentication factor; further generates authentication information according to the acquired information; and sends the authentication information to the server for verification, so as to achieve the purpose of Universal 2nd Factor authentication.

It is noted that the authentication information not only includes the signature information and the first value of the preset counter, but also includes the authentication factor, and the authentication factor is login information of the client terminal logging in to the server. As compared with the prior art, since an attacker cannot learn the authentication factor, the attacker cannot pass the two-factor authentication even if the attacker generates a large counter value; thus, the occurrence of a cloning operation can be effectively detected, and the technical effect of enhancing authentication accuracy and improving user experience can be achieved.

Accordingly, the solution of Embodiment 5 provided in the present disclosure solves the technical problem of low authentication accuracy caused by failure to effectively detect the occurrence of a cloning operation in authentication methods in the prior art.

In the aforementioned embodiment of the present disclosure, the client terminal is further configured to read a historical login time from the authentication device, where the historical login time is used for representing a login time of the client terminal successfully logging in to the server last time; and read a current login time, where the current login time is used for representing a login time of the client terminal currently logging in to the server.

Optionally, in the case that the client terminal logs in to the server for the first time, the historical login time is used for representing a time of performing a registration operation on the server by the client terminal, where in the case that the client terminal performs the registration operation on the server, the client terminal generates the login time according to the current login time.

In the aforementioned embodiment of the present disclosure, the client terminal is further configured to read a historical value of a sub-counter corresponding to a target application from the authentication device, where the target application corresponds to the server; the historical value of the sub-counter is used for representing the number of historical logins of the client terminal logging in to the server and acquire a sum of the historical value and a first preset value to obtain the number of logins.

In the aforementioned embodiment of the present disclosure, the first value of the preset counter is a sum of historical values of sub-counters corresponding to all applications installed on the client terminal and the first preset value.

In the aforementioned embodiment of the present disclosure, the client terminal is further configured to acquire a historical mask corresponding to a target application that is sent by the server, where the historical mask is used for representing the number of historical logins of the client terminal logging in to the server; acquire a sum of the historical mask and a second preset value to obtain a current mask corresponding to the target application; and obtain the number of logins based on the current mask.

In the aforementioned embodiment of the present disclosure, the server is further configured to verify the signature information, the first value, and the authentication factor; if the authentication of the signature information, the first value, or the authentication factor fails, reject the login of the client terminal to the server and execute a corresponding control policy; and if the authentication of all the signature information, the first value, and the authentication factor succeeds, allow the client terminal to log in to the server.

In the aforementioned embodiment of the present disclosure, the server is further configured to compare a historical login time sent by the client terminal with a locally stored historical login time; if the historical login time sent by the client terminal is the same as the locally stored historical login time, determine that the authentication of the login time succeeds; and if the historical login time sent by the client terminal is different from the locally stored historical login time, determine that the authentication of the login time fails.

In the aforementioned embodiment of the present disclosure, the client terminal is further configured to, after the server determines that the authentication of the login time succeeds, update, according to a current login time, a historical login time stored in the authentication device; and the server is further configured to, after the server determines that the authentication of the login time succeeds, update the locally stored historical login time according to the current login time.

In the aforementioned embodiment of the present disclosure, the server is further configured to acquire a locally stored historical value of a sub-counter corresponding to a target application to obtain the locally stored number of historical logins; acquire a difference between the number of logins sent by the client terminal and the locally stored number of historical logins; judge whether the difference is a first preset value; if the difference is the first preset value, determine that the authentication of the number of logins succeeds; and if the difference is not the first preset value, determine that the authentication of the number of logins fails.

In the aforementioned embodiment of the present disclosure, the client terminal is further configured to, after the server determines that the authentication of the number of logins succeeds, update a historical value stored in the authentication device according to the number of logins; and the server is further configured to, after the server determines that the authentication of the number of logins succeeds, update the locally stored historical value according to the number of logins.

In the aforementioned embodiment of the present disclosure, the server is further configured to acquire a locally stored historical mask corresponding to a target application; obtain the locally stored number of historical logins according to the locally stored historical mask and the first value; judge whether a difference between the number of logins and the locally stored number of historical logins is a first preset value; if the difference is the first preset value, determine that the authentication of the number of logins succeeds; and if the difference is not the first preset value, determine that the authentication of the number of logins fails.

In the aforementioned embodiment of the present disclosure, the server is further configured to acquire a sum of the historical mask and a second preset value to obtain a current mask corresponding to the target application; and update the locally stored historical mask according to the current mask.

In the aforementioned embodiment of the present disclosure, the server is further configured to acquire a difference between a first value sent by the client terminal and a locally stored first value; judge whether the difference is within a preset range; if the difference is within the preset range, determine that the authentication of the first value succeeds; and if the difference is not within the preset range, determine that the authentication of the first value fails.

In the aforementioned embodiment of the present disclosure, the server is further configured to, in the case that the authentication of the first value fails, if the difference is less than a minimum of the preset range, execute a rollback control policy; if the difference is larger than a maximum of the preset range, execute a jump control policy; and if the first value sent by the client terminal exceeds a storage space of the server, execute an overflow control policy.

In the aforementioned embodiment of the present disclosure, the server is further configured to authenticate the signature information through a locally stored public key.

In the aforementioned embodiment of the present disclosure, the server is further configured to, in the case that the authentication of the authentication factor fails, reject the login of the client terminal; authenticate the client terminal again; and revoke the authentication factor.

In the aforementioned embodiment of the present disclosure, the client terminal is further configured to encrypt the authentication information to obtain encrypted authentication information; and send the encrypted authentication information to the server.

In the aforementioned embodiment of the present disclosure, the server is further configured to acquire a digital certificate of an authentication device installed on the client terminal; perform matching between the digital certificate and a certificate whitelist; and if the matching between the digital certificate and the certificate whitelist fails, execute an authentication device control policy.

In the aforementioned embodiment of the present disclosure, the client terminal is further configured to send a login request carrying a login account and a login password to the server, where the login request is verified by the server; and in the case that the verification of the login request succeeds, receive the challenge value and/or a historical mask corresponding to a target application that is sent by the server.

### Embodiment 6

According to this embodiment of the present disclosure, an embodiment of an authentication method is provided. It should be noted that the steps shown in the flowchart of the drawings may be performed in a computer system such as a set of computer-executable instructions. Although a logical order is shown in the flowchart, in some cases, the illustrated or described steps may be performed in a different order other than the one shown here.

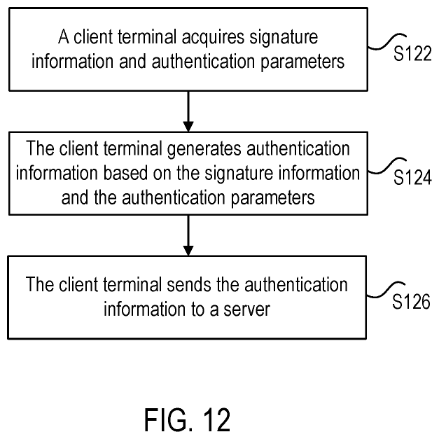

FIG. 12 is a flowchart of an authentication method according to Embodiment 6 of the present disclosure. As shown in FIG. 12, the method includes the following steps:

Step S122: a client terminal acquires signature information and authentication parameters, where the authentication parameters are used for representing login information and operation information of the client terminal logging in to a server.

Optionally, the authentication parameters include a first value and an authentication factor, where the first value is used for representing the number of operations of signing a challenge value sent by the server, the authentication factor is used for representing the login information of the client terminal logging in to the server, and the signature information is obtained by signing the challenge value.

Optionally, the client terminal may be connected to an authentication device, and an authentication factor may be stored in a single-chip microcomputer or a secure element of the authentication device.

Optionally, the authentication factor may include at least one of the following: a login time and the number of logins.

Specifically, the aforementioned client terminal may be a computer terminal, the aforementioned server may be an application server, the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value).

Since it is impossible to detect the occurrence of cloning in all cases, in order to avoid the occurrence of cloning, an authentication factor that cannot be learned by an attacker may be added, which may be, for example, login information of the client terminal logging in to the application server last time and may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal, or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed, except that a new authentication factor is added in the single-chip microcomputer, so that no new security risks are introduced. When the SE has a large storage capacity, the authentication factor may be stored in the SE in order to increase security.

Step S124: the client terminal generates authentication information based on the signature information and the authentication parameters.

Step S126: the client terminal sends the authentication information to the server.

Optionally, the server is further configured to perform two-factor authentication on the authentication information.

In an alternative solution, in the authentication process, the application server may send a challenge value to the client terminal; the client terminal uses the U2F device to sign the challenge value according to its own master key (namely, a private key) to obtain signature information and meanwhile generate the value of a counter, read a newly added authentication factor, further generate authentication information according to the aforementioned information, and forward the authentication information to the application server through the browser for two-factor authentication. After receiving the authentication information, the application server needs to separately verify the signature information, the value of the counter, and the authentication factor, and can determine that the two-factor authentication succeeds only when all the information passes the verification.

In the solution provided in Embodiment 6 of the present disclosure, the client terminal acquires signature information and authentication parameters, further generates authentication information according to the acquired information, and sends the authentication information to the server for two-factor authentication, so as to achieve the purpose of Universal 2nd Factor authentication.

It is noted that the authentication information not only includes the signature information and the first value, but also includes the authentication factor, and the authentication factor is login information of the client terminal logging in to the server. As compared with the prior art, since an attacker cannot learn the authentication factor, the attacker cannot pass the two-factor authentication even if the attacker generates a large value; thus, the occurrence of a cloning operation can be effectively detected, and the technical effect of enhancing authentication accuracy and improving user experience can be achieved.

Accordingly, the solution of Embodiment 6 provided in the present disclosure solves the technical problem of low authentication accuracy caused by failure to effectively detect the occurrence of a cloning operation in authentication methods in the prior art.

### Embodiment 7

According to this embodiment of the present disclosure, an embodiment of an authentication method is provided. It should be noted that the steps shown in the flowchart of the drawings may be performed in a computer system such as a set of computer-executable instructions. Although a logical order is shown in the flowchart, in some cases, the illustrated or described steps may be performed in a different order other than the one shown here.

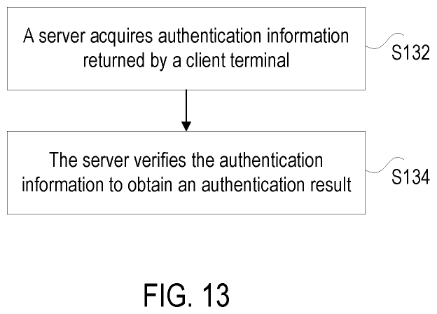

FIG. 13 is a flowchart of an authentication method according to Embodiment 7 of the present disclosure. As shown in FIG. 13, the method includes the following steps:

Step S132: a server acquires authentication information returned by a client terminal, where the authentication information is generated based on signature information and authentication parameters, and the authentication parameters are used for representing login information and operation information of the client terminal logging in to the server; and

Optionally, the authentication parameters include a first value and an authentication factor, where the first value is used for representing the number of operations of signing a challenge value sent by the server, the authentication factor is used for representing the login information of the client terminal logging in to the server, and the signature information is obtained by signing the challenge value.

Optionally, the client terminal may be connected to an authentication device, and an authentication factor may be stored in a single-chip microcomputer or a secure element of the authentication device.

Optionally, the authentication factor may include at least one of the following: a login time and the number of logins.

Specifically, the aforementioned client terminal may be a computer terminal, the aforementioned server may be an application server, the client terminal has a plurality of applications installed thereon and may log in to any application through a browser so as to log in to a corresponding application server. In order to implement two-factor authentication, the client terminal may be connected to a U2F device (namely, the aforementioned authentication device). The U2F device may sign, according to its own master key, a challenge value sent by the application server and meanwhile generate the value of a counter (namely, the aforementioned first value).

Since it is impossible to detect the occurrence of cloning in all cases, in order to avoid the occurrence of cloning, an authentication factor that cannot be learned by an attacker may be added, which may be, for example, login information of the client terminal logging in to the application server last time and may specifically include a login time of the last login of the client terminal, the number of logins of the client terminal logging in to the application server, and the like. The application server may selectively require the browser and the U2F to send an authentication factor according to requirements of different security levels. For example, if the security level is low, then the authentication factor may be just the login time of the last login of the client terminal, or just the number of logins of the client terminal logging in to the application server; if the security level is high, then the authentication factor may include the login time of the last login of the client terminal and the number of logins of the client terminal logging in to the application server.

In order to ensure the security of the newly added authentication factor, due to the limited storage space of the secure element (SE), the authentication factor may be stored in the single-chip microcomputer of the U2F device. The existing counter mechanism is not changed, except that a new authentication factor is added in the single-chip microcomputer, so that no new security risks are introduced. When the SE has a large storage capacity, the authentication factor may be stored in the SE in order to increase security.

Step S134: the server verifies the authentication information to obtain an authentication result.

In an alternative solution, in the authentication process, the application server may send a challenge value to the client terminal; the client terminal uses the U2F device to sign the challenge value according to its own master key (namely, a private key) to obtain signature information and meanwhile generate the value of a counter, read a newly added authentication factor, further generate authentication information according to the aforementioned information, and forward the authentication information to the application server through the browser for two-factor authentication. After receiving the authentication information, the application server needs to separately verify the signature information, the value of the counter, and the authentication factor, and can determine that the two-factor authentication succeeds only when all the information passes the verification.

In the solution provided in Embodiment 7 of the present disclosure, the client terminal acquires signature information and authentication parameters, further generates authentication information according to the acquired information, and sends the authentication information to the server; the server acquires the authentication information and verifies the authentication information to obtain an authentication result, so as to achieve the purpose of Universal 2nd Factor authentication.

It is noted that the authentication information not only includes the signature information and the first value, but also includes the authentication factor, and the authentication factor is login information of the client terminal logging in to the server. As compared with the prior art, since an attacker cannot learn the authentication factor, the attacker cannot pass the two-factor authentication even if the attacker generates a large value; thus, the occurrence of a cloning operation can be effectively detected, and the technical effect of enhancing authentication accuracy and improving user experience can be achieved.

Accordingly, the solution of Embodiment 7 provided in the present disclosure solves the technical problem of low authentication accuracy caused by failure to effectively detect the occurrence of a cloning operation in authentication methods in the prior art.

### Embodiment 8

According to this embodiment of the present disclosure, an identity authentication system is further provided, which includes:

a processor; and

a memory, connected to the processor and configured to provide to the processor instructions for processing the following processing steps: acquiring, by a client terminal, signature information, a first value of a preset counter, and an authentication factor, where the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, where the server verifies the authentication information.

In the solution provided in Embodiment 8 of the present disclosure, the client terminal acquires signature information, a first value of a preset counter, and an authentication factor; further generates authentication information according to the acquired information; and sends the authentication information to the server for verification, so as to achieve the purpose of Universal 2nd Factor authentication.

It is noted that the authentication information not only includes the signature information and the first value of the preset counter, but also includes the authentication factor, and the authentication factor is login information of the client terminal logging in to the server. As compared with the prior art, since an attacker cannot learn the authentication factor, the attacker cannot pass the two-factor authentication even if the attacker generates a large counter value; thus, the occurrence of a cloning operation can be effectively detected, and the technical effect of enhancing authentication accuracy and improving user experience can be achieved.

Accordingly, the solution of Embodiment 8 provided in the present disclosure solves the technical problem of low authentication accuracy caused by failure to effectively detect the occurrence of a cloning operation in authentication methods in the prior art.

### Embodiment 9

This embodiment of the present disclosure may provide a computer terminal, and the computer terminal may be any computer terminal device in a computer terminal group. Optionally, in this embodiment, the aforementioned computer terminal may be replaced with a terminal device such as a mobile terminal.

Optionally, in this embodiment, the aforementioned computer terminal may be located in at least one network device in a plurality of network devices of a computer network.

In this embodiment, the aforementioned computer terminal may execute program code of the following steps in the authentication method: acquiring, by a client terminal, signature information, a first value of a preset counter, and an authentication factor, where the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, where the server verifies the authentication information.

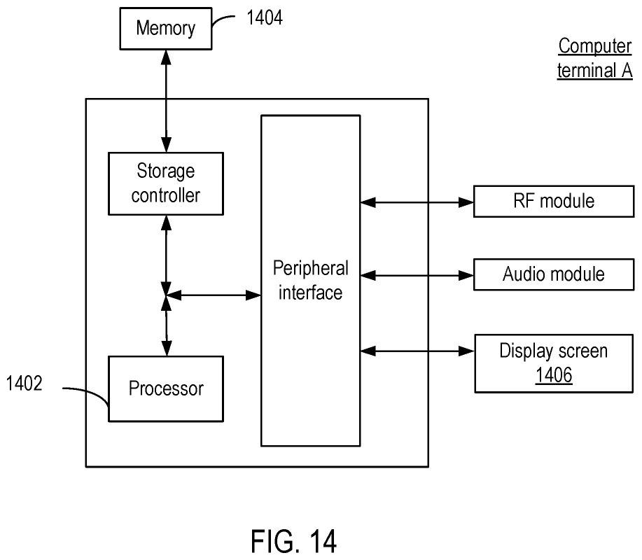

Optionally, FIG. 14 is a structural block diagram of a computer terminal according to this embodiment of the present disclosure. As shown in FIG. 14, the computer terminal A may include one or a plurality of (only one is shown in the figure) processors 1402 and a memory 1404.

The memory 1404 may be configured to store software programs and modules, such as program instructions/modules corresponding to the authentication method and apparatus in the embodiments of the present disclosure. The processor 1402 runs the software programs and modules stored in the memory 1404, so as to execute various functional applications and data processing, namely, implement the aforementioned authentication method. The memory 1404 may include a high-speed random access memory, and may also include a non-volatile memory such as one or a plurality of magnetic storage apparatuses, a flash memory, or other non-volatile solid-state memories. In some examples, the memory 1404 may further include memories arranged remotely with respect to the processor 1402. The remote memories may be connected to the terminal A via a network. Examples of the aforementioned network include, but are not limited to, the Internet, intranets, local area networks, mobile communication networks, and the combinations thereof.

The processor 1402 may invoke, through a transmission apparatus, information and applications stored in the memory 1404, so as to perform the following steps: acquiring, by a client terminal, signature information, a first value of a preset counter, and an authentication factor, where the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, where the server verifies the authentication information.

Optionally, the aforementioned processor may further execute program code of the following step: the client terminal is connected to an authentication device, and the authentication factor is stored in a single-chip microcomputer or a secure element of the authentication device.

Optionally, the aforementioned processor may further execute program code of the following step: the authentication factor includes at least one of the following: a login time and the number of logins.

Optionally, the aforementioned processor may further execute program code of the following steps: reading, by the client terminal, a historical login time from the authentication device, where the historical login time is used for representing a login time of the client terminal successfully logging in to the server last time; and reading, by the client terminal, a current login time, where the current login time is used for representing a login time of the client terminal currently logging in to the server.

Optionally, the aforementioned processor may further execute program code of the following step: in the case that the client terminal logs in to the server for the first time, the historical login time is used for representing a time of performing a registration operation on the server by the client terminal, where in the case that the client terminal performs the registration operation on the server, the client terminal generates the login time according to the current login time.

Optionally, the aforementioned processor may further execute program code of the following steps: reading, by the client terminal, a historical value of a sub-counter corresponding to a target application from the authentication device, where the target application corresponds to the server, and the historical value of the sub-counter is used for representing the number of historical logins of the client terminal logging in to the server; and acquiring, by the client terminal, a sum of the historical value and a first preset value to obtain the number of logins.

Optionally, the aforementioned processor may further execute program code of the following step: the first value of the preset counter is a sum of historical values of sub-counters corresponding to all applications installed on the client terminal and the first preset value.

Optionally, the aforementioned processor may further execute program code of the following steps: acquiring, by the client terminal, a historical mask corresponding to a target application that is sent by the server, where the historical mask is used for representing the number of historical logins of the client terminal logging in to the server; acquiring, by the client terminal, a sum of the historical mask and a second preset value to obtain a current mask corresponding to the target application; and obtaining, by the client terminal, the number of logins based on the current mask.

Optionally, the aforementioned processor may further execute program code of the following steps: after the client terminal sends the authentication information to the server, verifying, by the server, the signature information, the first value, and the authentication factor; if the authentication of the signature information, the first value, or the authentication factor fails, then rejecting, by the server, the login of the client terminal to the server and executing a corresponding control policy; and if the authentication of all the signature information, the first value, and the authentication factor succeeds, then allowing, by the server, the client terminal to log in to the server.

Optionally, the aforementioned processor may further execute program code of the following steps: comparing, by the server, a historical login time sent by the client terminal with a locally stored historical login time; if the historical login time sent by the client terminal is the same as the locally stored historical login time, then determining, by the server, that the authentication of the login time succeeds; and if the historical login time sent by the client terminal is different from the locally stored historical login time, then determining, by the server, that the authentication of the login time fails.

Optionally, the aforementioned processor may further execute program code of the following steps: after the server determines that the authentication of the login time succeeds, updating, by the client terminal according to a current login time, a historical login time stored in the authentication device; and updating, by the server, the locally stored historical login time according to the current login time.

Optionally, the aforementioned processor may further execute program code of the following steps: acquiring, by the server, a locally stored historical value of a sub-counter corresponding to a target application to obtain the locally stored number of historical logins; acquiring, by the server, a difference between the number of logins sent by the client terminal and the locally stored number of historical logins; judging, by the server, whether the difference is a first preset value; if the difference is the first preset value, then determining, by the server, that the authentication of the number of logins succeeds; and if the difference is not the first preset value, then determining, by the server, that the authentication of the number of logins fails.

Optionally, the aforementioned processor may further execute program code of the following steps: after the server determines that the authentication of the number of logins succeeds, updating, by the client terminal according to the number of logins, a historical value stored in the authentication device; and updating, by the server, the locally stored historical value according to the number of logins.

Optionally, the aforementioned processor may further execute program code of the following steps: acquiring, by the server, a locally stored historical mask corresponding to a target application; obtaining, by the server, the locally stored number of historical logins according to the locally stored historical mask and the first value; judging, by the server, whether a difference between the number of logins and the locally stored number of historical logins is a first preset value; if the difference is the first preset value, then determining, by the server, that the authentication of the number of logins succeeds; and if the difference is not the first preset value, then determining, by the server, that the authentication of the number of logins fails.

Optionally, the aforementioned processor may further execute program code of the following steps: after the server determines that the authentication of the number of logins succeeds, acquiring, by the server, a sum of the historical mask and a second preset value to obtain a current mask corresponding to the target application; and updating, by the server, the locally stored historical mask according to the current mask.

Optionally, the aforementioned processor may further execute program code of the following steps: acquiring, by the server, a difference between a first value sent by the client terminal and a locally stored first value; judging, by the server, whether the difference is within a preset range; if the difference is within the preset range, then determining, by the server, that the authentication of the first value succeeds; and if the difference is not within the preset range, then determining, by the server, that the authentication of the first value fails.

Optionally, the aforementioned processor may further execute program code of the following steps: in the case that the authentication of the first value fails, if the difference is less than a minimum of the preset range, then executing, by the server, a rollback control policy; if the difference is larger than a maximum of the preset range, then executing, by the server, a jump control policy; and if the first value sent by the client terminal exceeds a storage space of the server, then executing, by the server, an overflow control policy.

Optionally, the aforementioned processor may further execute program code of the following step: authenticating, by the server, the signature information through a locally stored public key.

Optionally, the aforementioned processor may further execute program code of the following steps: in the case that the authentication of the authentication factor fails, rejecting, by the server, the login of the client terminal; authenticating, by the server, the client terminal again; and revoking, by the server, the authentication factor.

Optionally, the aforementioned processor may further execute program code of the following steps: encrypting, by the client terminal, the authentication information to obtain encrypted authentication information; and sending, by the client terminal, the encrypted authentication information to the server.

Optionally, the aforementioned processor may further execute program code of the following steps: after the client terminal sends the authentication information to the server, acquiring, by the server, a digital certificate of an authentication device installed on the client terminal; performing, by the server, matching between the digital certificate and a certificate whitelist; and if the matching between the digital certificate and the certificate whitelist fails, then executing, by the server, an authentication device control policy.

Optionally, the aforementioned processor may further execute program code of the following steps: before the client terminal acquires the signature information, the first value of the preset counter, and the authentication factor, sending, by the client terminal, a login request carrying a login account and a login password to the server, where the login request is verified by the server; and in the case that the verification of the login request succeeds, receiving, by the client terminal, the challenge value and/or a historical mask corresponding to a target application that is sent by the server.

By means of this embodiment of the present disclosure, the client terminal acquires signature information, a first value of a preset counter, and an authentication factor; further generates authentication information according to the acquired information; and sends the authentication information to the server for verification, so as to achieve the purpose of Universal 2nd Factor authentication.

It is noted that the authentication information not only includes the signature information and the first value of the preset counter, but also includes the authentication factor and the authentication factor is login information of the client terminal logging in to the server. As compared with the prior art, since an attacker cannot learn the authentication factor, the attacker cannot pass the two-factor authentication even if the attacker generates a large counter value; thus, the occurrence of a cloning operation can be effectively detected, and the technical effect of enhancing authentication accuracy and improving user experience can be achieved.

Accordingly, the solution of this embodiment of the present disclosure solves the technical problem of low authentication accuracy caused by failure to effectively detect the occurrence of a cloning operation in authentication methods in the prior art.

The processor may invoke, through the transmission apparatus, information and applications stored in the memory, so as to perform the following steps: sending, by the server, a challenge value to the client terminal; acquiring, by the server, authentication information returned by the client terminal, where the authentication information is generated based on signature information, a first value of a preset counter, and an authentication factor; the signature information is obtained by signing the challenge value, the first value is used for representing the number of operations of signing the challenge value, and the authentication factor is used for representing login information of the client terminal logging in to the server; and verifying, by the server, the authentication information.

Optionally, the aforementioned processor may further execute program code of the following steps: verifying, by the server, the signature information, the first value, and the authentication factor; if the authentication of the signature information, the first value, or the authentication factor fails, then rejecting, by the server, the login of the client terminal to the server and executing a corresponding control policy; and if the authentication of all the signature information, the first value, and the authentication factor succeeds, then allowing, by the server, the client terminal to log in to the server.

The processor may invoke, through the transmission apparatus, information and applications stored in the memory, so as to perform the following steps: acquiring, by a client terminal, signature information and authentication parameters, where the authentication parameters are used for representing login information and operation information of the client terminal logging in to a server; and generating, by the client terminal, authentication information based on the signature information and the authentication parameters.

Optionally, the authentication parameters include a first value and an authentication factor, where the first value is used for representing the number of operations of signing a challenge value sent by the server, the authentication factor is used for representing the login information of the client terminal logging in to the server, and the signature information is obtained by signing the challenge value; and the server is further configured to verify the authentication information.

The processor may invoke, through the transmission apparatus, information and applications stored in the memory, so as to perform the following steps: acquiring, by the server, authentication information returned by the client terminal, where the authentication information is generated based on signature information and authentication parameters, and the authentication parameters are used for representing login information and operation information of the client terminal logging in to the server; and verifying, by the server, the authentication information to obtain an authentication result.

Those of ordinary skill in the art can understand that the structure shown in FIG. 14 is merely illustrative, and the computer terminal may also be a terminal device such as a smart phone (for example, an Android phone or an iOS phone), a tablet computer, a palm computer, a mobile Internet device (MID), or a PAD. FIG. 14 does not limit the structure of the aforementioned electronic apparatus. For example, the computer terminal A may also include more or fewer components than those shown in FIG. 14 (for example, a network interface or a display apparatus 1406) or have a different configuration from that shown in FIG. 14.

Those of ordinary skill in the art can understand that all or some of the steps in various methods in the above embodiments may be implemented through a program instructing hardware related to a terminal device. The program may be stored in a computer-readable storage medium. The storage medium may include a flash disk, a read-only memory (ROM), a random access memory (RAM), a magnetic disk, or an optical disc.

### Embodiment 10

This embodiment of the present disclosure further provides a storage medium. Optionally, in this embodiment, the aforementioned storage medium may be used for storing program code executed in the authentication method provided in Embodiment 1.

Optionally, in this embodiment, the aforementioned storage medium may be located in any computer terminal in a computer terminal group of a computer network, or located in any mobile terminal in a mobile terminal group.

Optionally, in this embodiment, the storage medium is configured to store program code for performing the following steps: acquiring, by a client terminal, signature information, a first value of a preset counter, and an authentication factor, where the signature information is obtained by signing a challenge value sent by a server, the first value is used for representing the number of operations of signing the challenge value, and the authentication factor is used for representing login information of the client terminal logging in to the server; generating, by the client terminal, authentication information based on the signature information, the first value, and the authentication factor; and sending, by the client terminal, the authentication information to the server, where the server verifies the authentication information.

Optionally, in this embodiment, the storage medium is configured to store program code for performing the following steps: sending, by the server, a challenge value to the client terminal; acquiring, by the server, authentication information returned by the client terminal, where the authentication information is generated based on signature information, a first value of a preset counter, and an authentication factor; the signature information is obtained by signing the challenge value, the first value is used for representing the number of operations of signing the challenge value, and the authentication factor is used for representing login information of the client terminal logging in to the server; and verifying, by the server, the authentication information.

Optionally, in this embodiment, the storage medium is configured to store program code for performing the following steps: acquiring, by a client terminal, signature information and authentication parameters, where the authentication parameters are used for representing login information and operation information of the client terminal logging in to a server; and generating, by the client terminal, authentication information based on the signature information and the authentication parameters.

Optionally, in this embodiment, the storage medium is configured to store program code for performing the following steps: acquiring, by the server, authentication information returned by the client terminal, where the authentication information is generated based on signature information and authentication parameters, and the authentication parameters are used for representing login information and operation information of the client terminal logging in to the server; and verifying, by the server, the authentication information to obtain an authentication result.

The sequence numbers of the foregoing embodiments of the present disclosure are merely for description and do not imply the preference among the embodiments.

In the embodiments of the present disclosure, the description of each embodiment has its own focus; for the part not described in detail in one embodiment, reference can be made to the relevant description of other embodiments.

In the several embodiments provided in the present disclosure, it should be understood that the disclosed technical content may be implemented in other manners. The apparatus embodiment described above is merely exemplary. For example, the division of the units is merely a logical function division; other divisions in practical implementation may exist, like a plurality of units or components can be combined or can be integrated into another system; or some features can be ignored or not executed. Additionally, the intercoupling, direct coupling, or communication connection displayed or discussed may be electrical or other forms through some interfaces, indirect coupling or communication connection of the units or the modules.

The units described as separate parts may or may not be physically separated; the parts shown as units may or may not be physical units, which may be located in one place or may be distributed onto a plurality of network units. The objective of the solution of this embodiment may be achieved by selecting part or all of the units according to actual requirements.

In addition, various functional units in the embodiments of the present disclosure may be integrated in one processing unit, or the units exist physically and separately, or two or more units are integrated in one unit. The integrated unit may be implemented in the form of hardware and may also be implemented in the form of a software functional unit.

The integrated unit, if implemented in the form of a software functional unit and sold or used as an independent product, may be stored in a computer-readable storage medium. Based on such understanding, the essence of the technical solutions of the present disclosure or the part that makes contributions to the prior art, or all or part of the technical solutions may be embodied in the form of a software product. The computer software product is stored in a storage medium and includes several instructions for instructing a computer apparatus (which may be a personal computer, a server, a network apparatus, or the like) to perform all or part of the steps in the methods described in the embodiments of the present disclosure. The storage medium includes: a USB flash disk, a read-only memory (ROM), a random access memory (RAM), a mobile hard disk drive, a magnetic disk, an optical disc, or any other medium that can store program code.

The above descriptions are merely preferred embodiments of the present disclosure. It should be pointed out that those of ordinary skill in the art can make several improvements and modifications without departing from the principle of the present disclosure, and the improvements and modifications should also be construed as falling within the protection scope of the present disclosure.

What is claimed is:

1. An authentication method, comprising:
acquiring, by a client terminal, signature information, a first value, and an authentication factor, wherein the signature information is obtained by signing a challenge value sent by a server, the first value is used for representing the number of operations of signing the challenge value, and the authentication factor is used for representing login information of the client terminal logging in to the server;
generating, by the client terminal, authentication information based on the signature information, the first value, and the authentication factor; and
sending, by the client terminal, the authentication information to the server, wherein the server verifies the authentication information.

2. The method according to claim 1, wherein the client terminal is connected to an authentication device, and the authentication factor is stored in a single-chip microcomputer or a secure element of the authentication device.

3. The method according to claim 2, wherein the authentication factor comprises at least one of the following: a login time and a number of logins.

4. The method according to claim 3, wherein the acquiring, by the client terminal, the login time comprises:
reading, by the client terminal, a historical login time from the authentication device, wherein the historical login time is used for representing a login time of the client terminal successfully logging in to the server last time; and
reading, by the client terminal, a current login time, wherein the current login time is used for representing a login time of the client terminal currently logging in to the server.

5. The method according to claim 4, wherein in the case that the client terminal logs in to the server for the first time, the historical login time is used for representing a time of performing a registration operation on the server by the client terminal, wherein in the case that the client terminal performs the registration operation on the server, the client terminal generates the login time according to the current login time.

6. The method according to claim 3, wherein the acquiring, by the client terminal, the number of logins comprises:
reading, by the client terminal, a historical value corresponding to a target application from the authentication device, wherein the target application corresponds to the server, and the historical value is used for representing the number of historical logins of the client terminal logging in to the server; and
acquiring, by the client terminal, a sum of the historical value and a first preset value to obtain the number of logins.

7. The method according to claim 6, wherein the first value is a sum of historical values corresponding to all applications installed on the client terminal and the first preset value.

8. The method according to claim 3, wherein the acquiring, by the client terminal, the number of logins comprises:
acquiring, by the client terminal, a historical mask corresponding to a target application that is sent by the server, wherein the historical mask is used for representing the number of historical logins of the client terminal logging in to the server;
acquiring, by the client terminal, a sum of the historical mask and a second preset value to obtain a current mask corresponding to the target application; and
obtaining, by the client terminal, the number of logins based on the current mask.

9. The method according to claim 3, wherein after the client terminal sends the authentication information to the server, the method further comprises:
verifying, by the server, the signature information, the first value, and the authentication factor;
if the authentication of the signature information, the first value, or the authentication factor fails, then rejecting, by the server, the login of the client terminal to the server and executing a corresponding control policy; and
if the authentication of all the signature information, the first value, and the authentication factor succeeds, then allowing, by the server, the client terminal to log in to the server.

10. The method according to claim 9, wherein the authenticating, by the server, the login time comprises:
comparing, by the server, a historical login time sent by the client terminal with a locally stored historical login time;
if the historical login time sent by the client terminal is the same as the locally stored historical login time, then determining, by the server, that the authentication of the login time succeeds; and
if the historical login time sent by the client terminal is different from the locally stored historical login time, then determining, by the server, that the authentication of the login time fails.

11. An authentication method, comprising:
sending, by a server, a challenge value to a client terminal;
acquiring, by the server, authentication information returned by the client terminal, wherein the authentication information is generated based on signature information, a first value, and an authentication factor, the signature information is obtained by signing the challenge value, the first value is used for representing the number of operations of signing the challenge value, and the authentication factor is used for representing login information of the client terminal logging in to the server; and
verifying, by the server, the authentication information.

12. The method according to claim 11, wherein the authentication factor comprises at least one of the following: a login time and a number of logins.

13. The method according to claim 11, wherein the verifying, by the server, the authentication information comprises:
verifying, by the server, the signature information, the first value, and the authentication factor;
if the authentication of the signature information, the first value, or the authentication factor fails, then rejecting, by the server, the login of the client terminal to the server and executing the corresponding control policy; and
if the authentication of all the signature information, the first value, and the authentication factor succeeds, then allowing, by the server, the client terminal to log in to the server.

14. The method according to claim 13, wherein the authentication factor comprises at least one of the following: a login time and a number of logins.

15. The method according to claim 14, wherein the authenticating, by the server, the login time comprises:
comparing, by the server, a historical login time sent by the client terminal with a locally stored historical login time;
if the historical login time sent by the client terminal is the same as the locally stored historical login time, then determining, by the server, that the authentication of the login time succeeds; and
if the historical login time sent by the client terminal is different from the locally stored historical login time, then determining, by the server, that the authentication of the login time fails.

16. The method according to claim 11, further comprising:
receiving, by the server, encrypted authentication information sent by the client terminal, wherein the encrypted authentication information is obtained by encrypting the authentication information by the client terminal.

17. An authentication system, comprising:
a server, configured to send a challenge value; and
a client terminal, having a communication relationship with the server, and configured to generate authentication information based on signature information, a first value, and an authentication factor, wherein the signature information is obtained by signing the challenge value, the first value is used for representing the number of operations of signing the challenge value, and the authentication factor comprises one of the following: a login time and a second value corresponding to a target application,
wherein the server is further configured to verify the authentication information to obtain an authentication result.

18. The system according to claim 17, wherein the client terminal is connected to an authentication device, and an authentication factor is stored in a single-chip microcomputer or a secure element of the authentication device.

19. The system according to claim 17, wherein the client terminal is further configured to send a login request carrying a login account and a login password to the server, wherein the login request is verified by the server; and in the case that the verification of the login request succeeds, receive the challenge value corresponding to the target application that is sent by the server.

20. The system according to claim 17, wherein the server is further configured to authenticate the signature information through a locally stored public key.
